(19) United States
(12) Patent Application Publication
(10) Pub. No.: US 2026/0148280 A1
(43) Pub. Date: May 28, 2026

(54) GENERATING A RECOMMENDATION SYSTEM USING CONFORMAL PREDICTION AND DIFFUSION MODELS

(71) Applicant: Dell Products L.P., Round Rock, TX (US)

(72) Inventors: Kailash Talreja, Mumbai (IN); Saurabh Jha, Leander, TX (US)

(21) Appl. No.: 18/962,736

(22) Filed: Nov. 27, 2024

(51) Int. Cl. G06Q 30/0601; H04L 67/1396

(52) U.S. Cl. CPC G06Q 30/0631; G06Q 30/0641; H04L 67/1396

(57) ABSTRACT

A method for managing recommendation generation includes: receiving a request from a user; obtaining data; initiating monitor of actions of the user; performing preprocessing on the data to obtain preprocessed data; determining, based on the preprocessed data, a preference score of the user; analyzing the actions to obtain a result; inferring, based on the result, a current preference of the user; updating the preference score to obtain an updated preference score of the user; generating, based on the updated preference score, a potential recommendation; generating an optimized recommendation based on the potential recommendations; determining a reliability of the optimized recommendation; generating a ranked list of recommendations; initiating display of the ranked list to the user; making a determination that a negative feedback is received from the user; updating the ranked list to obtain an updated ranked list; and initiating display of the updated ranked list to the user.

### BACKGROUND

Devices are often capable of performing certain functionalities that other devices are not configured to perform or are not capable of performing. In such scenarios, it may be desirable to adapt one or more systems to enhance the functionalities of devices that cannot perform those functionalities.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example and are not meant to limit the scope of the claims.

FIG. 1 shows a diagram of a system in accordance with one or more embodiments disclosed herein.

FIG. 2 shows a diagram of an infrastructure node in accordance with one or more embodiments disclosed herein.

FIGS. 3.1-3.2 show a method for managing recommendation generation in accordance with one or more embodiments disclosed herein.

FIG. 4 shows a diagram of a computing device in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding of one or more embodiments disclosed herein. However, it will be apparent to one of ordinary skill in the art that the one or more embodiments disclosed herein may be practiced without these specific details. In other instances, well-known features have not been described in detail to avoid unnecessarily complicating the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In today's rapidly evolving marketplace, organizations face major challenges in providing/delivering dynamic, personalized, and real-time product recommendations that not only cater to the immediate (e.g., urgent) needs of customers (e.g., users, people, etc.) but also align with strategic objectives of those organizations (e.g., maximizing profit margins of products, promoting high-margin products or newer strategic initiatives, etc.). Traditional recommendation systems (e.g., static recommendation systems) often struggle to dynamically adapt their suggestions (in real-time) to changing user inputs (e.g., actions, interactions, feedback, etc.), such as during the customization of sales quotes, and typically fail to consider the broader and/or strategic goals/objectives of organizations, such as product margin optimization. This limitation hinders the ability to provide personalized and relevant recommendations that reflect the current preferences and needs of a corresponding user, thereby affecting the user experience and satisfaction negatively.

Traditional recommendation systems also require substantial computational/computing resources to generate and/or update recommendations. This inefficiency becomes particularly problematic as the volume of data and the number of users increase, in which the computational inefficiency and lack of adaptability in handling sparse data limit traditional recommendation systems' applicability in diverse market segments, making the need for a more sophisticated solution/framework evident.

Furthermore, traditional recommendation systems focus mainly on matching user preferences based on historical data, often overlooking strategic objectives of organizations. This oversight may lead to recommendations that, while relevant, do not necessarily contribute to the overall profitability and strategic objectives/goals of organizations.

Traditional recommendation systems also do not provide a robust mechanism to quantify the uncertainty (or confidence, reliability, etc.) associated with each of the generated recommendations. This lack of transparency may undermine trust in a recommendation system's suggestions/recommendations and hinder decision-making processes (e.g., users may receive recommendation without an understanding of how likely those recommendations are to meet/satisfy their needs or preferences), especially in scenarios in which managing risk and understanding the variability of outcomes are crucial.

From a different perspective, traditional recommendation systems fail to leverage the wealth of historical data regarding successful recommendation trajectories, in which these systems tend to focus on immediate user interactions and preferences without considering the long-term success patterns of previous recommendations. These systems often use static algorithms/models that do not adapt to the evolving nature of user preferences and market conditions, leading to less optimal recommendations that may not capture emerging trends or shifts in user behaviors. Further, traditional recommendation systems may not effectively align their recommendations with strategic objectives of organizations, as these systems lack the mechanism to integrate these objectives into their recommendation generation processes dynamically.

On the other hand, without confidence intervals, recommendations (e.g., generated by traditional recommendation systems) are often static and inflexible, not accounting for the variability and uncertainty inherent in predicting user preferences, especially in dynamic market environments. Traditional recommendation systems also do not offer a way to manage the risk associated with applying a particular recommendation, which may lead to suboptimal decision-making by users, especially in scenarios with high stakes or significant investment.

Additionally, in traditional recommendation systems, the primary focus is often on user preferences and engagement metrics, with less emphasis on the financial aspects of the recommended products or services. For example, traditional recommendation systems may recommend products (and/or services) based on popularity or user preference history without considering the varying profit margins of these products (and/or services). This approach may lead to missed opportunities for increasing revenue through the recommendation of higher-margin products (and/or services). As yet another example, traditional recommendation systems do not incorporate real-time financial data (e.g., current profit margins, cost variations, product inventory levels, etc.) into their recommendation generation processes. As a result, recommendations may not reflect the most financially beneficial options for the corresponding organization at any given time. As yet another example, traditional recommendation systems use static models that do not adjust to changing priorities of a corresponding organization, such as shifting focus to clear out overstocked inventory or promoting newer high-margin products.

Moreover, in traditional recommendation systems, the focus is often either on enhancing user engagement or on managing risks of a related organization, not adeptly handling both. For example, traditional recommendation systems prioritize user engagement without a robust mechanism for assessing and managing the risks associated with their recommendations, potentially compromising the quality (or reliability) of the recommendations. As yet another example, traditional recommendation systems focus on minimizing risks (e.g., inventory overstock, underperformance of high-margin products, etc.) without adequately considering user satisfaction and engagement, leading to a less personalized user experience for users. As yet another example, risk management in traditional recommendation systems relies on static rules (or thresholds) that do not adapt to changing market dynamics or user behaviors, potentially resulting in outdated or misaligned risk strategies.

In most cases, traditional recommendation systems rely on static models that utilize historical data to predict user preferences. Because of that: (i) these systems lack the capability to adapt recommendations in real-time based on user interactions (e.g., once a set of recommendations is generated, the recommendations may remain static until the next update cycle, which may lead to outdated or irrelevant recommendations), (ii) while traditional recommendation systems can offer personalized recommendations based on historical user data, these systems often struggle to immediately incorporate newer/updated user preferences (or behaviors), leading to a less personalized user experience, (iii) these systems may not efficiently utilize real-time data or newly emerging patterns, as these systems primarily depend on batch processing of historical data, and (iv) these systems may focus on user preferences without adequately considering objectives of organizations (e.g., maximizing margins, promoting strategic products, etc.).

As discussed above and to sum up, (i) while traditional recommendation systems/engines may offer personalized recommendations, these systems frequently rely on predefined user segments (or previous user behaviors), potentially overlooking real-time changes in user interests, (ii) traditional recommendation systems focus either on user engagement or on objectives of organizations, rarely integrating the two in a dynamic or context-sensitive manner, (iii) traditional recommendation systems do not provide a mechanism for quantifying the uncertainty (or reliability) of the recommendations, which can lead to less informed decision-making by the users/customers, and/or (iv) traditional recommendation systems typically operate on scheduled updates and lack the capability to adapt (in real-time) to changing user interactions and/or organization strategies.

For at least the reasons discussed above and without requiring resource-intensive efforts, a fundamentally different approach/framework is needed (e.g., a framework (or a multifaceted solution) that leverages advanced machine learning (ML) techniques/models to provide a dynamic, scalable, efficient, and strategically aligned recommendation engine that meets the complex demands of different sales environments).

Embodiments disclosed herein relate to methods and systems for managing recommendation generation. As a result of the processes discussed below, one or more embodiments disclosed herein advantageously introduce a framework designed to overcome at least the aforementioned challenges/issues. By integrating Direct Preference Optimization (DPO) approach, a Diffusion Optimization Model (DOM) with (or guided by) Trajectory Alignment (TA) methodology, and conformal prediction techniques, the dynamic and adaptable framework may respond user interactions (e.g., user actions, user preferences, etc.) in real-time (or near real-time). In this manner, the framework may generate personalized and contextually relevant product (or service) recommendations, for example, during a quote creation process, thereby enhancing user experience and satisfaction.

Moreover, the framework may address the critical need for strategic alignment with organization objectives through its sophisticated margin optimization strategy. By employing conformal prediction techniques, the framework not only recommends products (or services) based on user preferences and historical data but also prioritizes recommendations that are likely to maximize profit margins (e.g., of a related organization). This multi-dimensional approach (employed by the framework) ensures that the recommendations (e.g., dynamic, real-time product recommendations with an emphasis on margin optimization and adaptability to user preferences) are not only relevant and timely but also contribute to the overall profitability of the organization, marking a major advancement over traditional recommendation systems.

As discussed in detail below, the framework employs multiple approaches/techniques/models, each contributing to the framework's overall effectiveness and efficiency: (i) the DPO approach, to facilitate dynamic adjustment of recommendations based on real-time user interactions/actions and preferences, enhancing personalization and relevance (of the recommendations) without the computational complexity of, for example, reinforcement learning (RL); (ii) the DOM with the TA methodology, to employ generative models to efficiently generate high-quality product recommendations from limited/sparse data, in which the TA methodology ensures that the recommendation generation process is aligned with optimization trajectories, improving the framework's efficiency and adaptability (e.g., to different use cases in real-time); and (iii) conformal prediction techniques, to provide a mechanism for integrating organization objectives into the recommendation generation process (by utilizing these techniques, the framework may predict (with confidence) the products that are likely to maximize profit margins, aligning recommendations with strategic goals of organizations).

One or more embodiments disclosed herein make contributions, at least, to the field of product/service recommendation systems by: (i) dynamic real-time adaptability (where the framework can offer unparalleled real-time responsiveness to user inputs (e.g., feedback, actions, etc.) during a quote creation process, significantly enhancing experience of the related user, (ii) strategic goal alignment (where the framework can introduce a margin optimization strategy that aligns product/service recommendations with objectives of a corresponding organization, ensuring generated recommendations contribute to overall profitability of the organization, (iii) computational efficiency (where the framework can achieve high computational efficiency, enabling itself to provide rapid, high-quality recommendations even in use cases with sparse data), and (iv) scalability and versatility (where the framework can demonstrate scalability and applicability across various industries and market segments, addressing a wide range of complex recommendation scenarios).

Further, one or more embodiments disclosed herein enable organizations to use the framework for enhancing user/customer experience and increasing operational efficiency. As indicated above, the framework provides a solution to product (or service) recommendations, deeply integrated with a related organization's strategic objectives, operational efficiency, and customer engagement strategies. For example, by providing real-time, personalized recommendations that adapt to customer preferences and interactions, the framework may significantly enhance the customer experience. This level of personalization fosters greater customer satisfaction and loyalty, which is crucial for organizations involved in customer care and order-to-cash processes. As yet another example, the framework's ability to generate recommendations efficiently, without the need for extensive computational resources, may align with the operational goals of minimizing costs while maximizing output. This efficiency is particularly beneficial for organizations looking to streamline their order-to-cash and disbursement processes.

As yet another example, through its conformal prediction and margin optimization strategies, the framework may ensure that recommendations not only cater to customer preferences but also align with objectives (of organizations) about maximizing profitability. This strategic alignment is vital for sales compensation planning and overall financial health (of organizations). As yet another example, the employment of conformal prediction techniques (by the framework) may offer a quantifiable measure of confidence in each recommendation, providing a form of risk management. This feature enables organizations to make informed decisions that balance customer satisfaction with financial outcomes, crucial for disbursement and sales compensation planning.

From a different perspective, one or more embodiments disclosed herein may have a huge potential for broader adoption across different industries. The framework is generic and can be easily adapted to various use cases. For example, in retail, the framework can dynamically suggest products that maximize margins while considering customer buying habits/patterns, significantly boosting cross-sell and up-sell opportunities (for organizations). As yet another example, for manufacturers, the framework may recommend configurations of products that optimize for both manufacturing efficiency and customer requirements, enhancing product customization and profitability. As yet another example, in healthcare, personalized recommendations (generated by the framework) may improve patient care by suggesting treatments (or services) tailored to patient history, improving outcomes and patient satisfaction. As yet another example, financial institutions may leverage the framework to recommend financial products (or services) that align with customer financial goals and risk profiles, enhancing customer advisory services.

The following describes various embodiments disclosed herein.

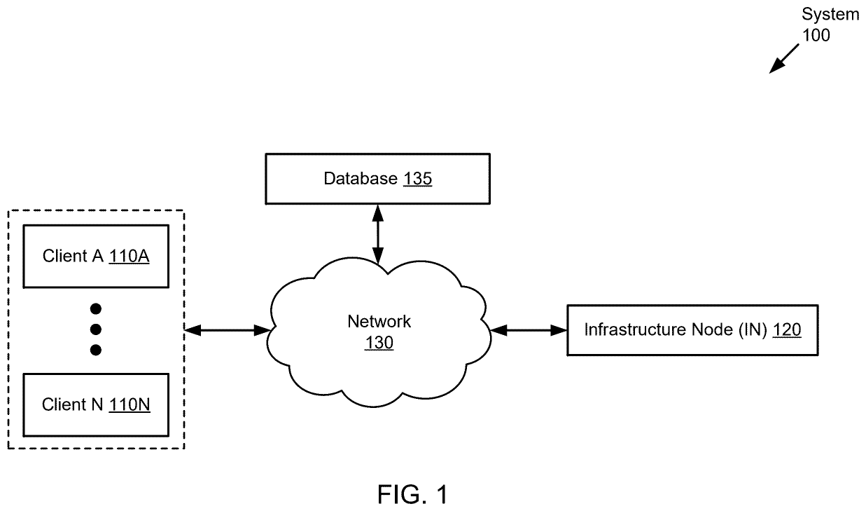

FIG. 1 shows a diagram of a system (100) in accordance with one or more embodiments disclosed herein. The system (100) includes any number of clients (e.g., Client A (110A), Client N (110N), etc.), a network (130), any number of infrastructure nodes (IN) (e.g., 120), and a database (135). The system (100) may include additional, fewer, and/or different components without departing from the scope of the embodiments disclosed herein. Each component may be operably/operatively connected to any of the other components via any combination of wired and/or wireless connections. Each component illustrated in FIG. 1 is discussed below.

In one or more embodiments, the clients (e.g., 110A, 110N, etc.), the IN (120), the network (130), and the database (135) may be (or may include) physical hardware or logical devices, as discussed below. While FIG. 1 shows a specific configuration of the system (100), other configurations may be used without departing from the scope of the embodiments disclosed herein. For example, although the clients (e.g., 110A, 110N, etc.) and the IN (120) are shown to be operatively connected through a communication network (e.g., 130), the clients (e.g., 110A, 110N, etc.) and the IN (120) may be directly connected (e.g., without an intervening communication network).

Further, the functioning of the clients (e.g., 110A, 110N, etc.) and the IN (120) is not dependent upon the functioning and/or existence of the other components (e.g., devices) in the system (100). Rather, the clients and the IN may function independently and perform operations locally that do not require communication with other components. Accordingly, embodiments disclosed herein should not be limited to the configuration of components shown in FIG. 1.

As used herein, “communication” may refer to simple data passing, or may refer to two or more components coordinating a job. As used herein, the term “data” is intended to be broad in scope. In this manner, that term embraces, for example (but not limited to): a data stream (or stream data), data chunks, data blocks, atomic data, emails, objects of any type, files of any type (e.g., media files, spreadsheet files, database files, etc.), contacts, directories, sub-directories, volumes, etc.

In one or more embodiments, although terms such as “document”, “file”, “segment”, “block”, or “object” may be used by way of example, the principles of the present disclosure are not limited to any particular form of representing and storing data or other information. Rather, such principles are equally applicable to any object capable of representing information.

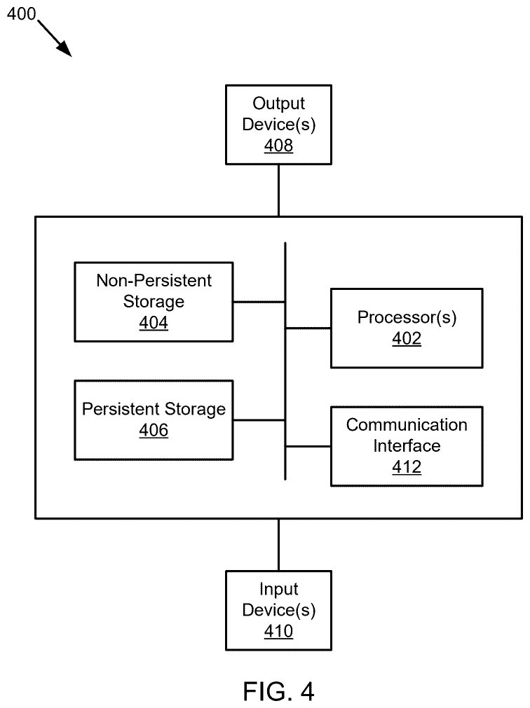

In one or more embodiments, the system (100) may be a distributed system (e.g., a data processing environment) and may deliver at least computing power (e.g., real-time (on the order of milliseconds (ms) or less) network monitoring, server virtualization, etc.), storage capacity (e.g., data backup), and data protection (e.g., software-defined data protection, disaster recovery, etc.) as a service to users of clients (e.g., 110A, 110N, etc.). For example, the system may be configured to organize unbounded, continuously generated data into a data stream. The system (100) may also represent a comprehensive middleware layer executing on computing devices (e.g., 400, FIG. 4) that supports application and storage environments.

In one or more embodiments, the system (100) may support one or more virtual machine (VM) environments, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

To provide computer-implemented services to the users, the system (100) may perform some computations (e.g., data collection, distributed processing of collected data, etc.) locally (e.g., at the users' site using the clients (e.g., 110A, 110N, etc.)) and other computations remotely (e.g., away from the users' site using the IN (120)) from the users. By doing so, the users may utilize different computing devices (e.g., 400, FIG. 4) that have different quantities of computing resources (e.g., processing cycles, memory, storage, etc.) while still being afforded a consistent user experience. For example, by performing some computations remotely, the system (100) (i) may maintain the consistent user experience provided by different computing devices even when the different computing devices possess different quantities of computing resources, and (ii) may process data more efficiently in a distributed manner by avoiding the overhead associated with data distribution and/or command and control via separate connections.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user/customer of a client (described below). The resource may be delivered to the client via, for example (but not limited to): conventional installation, a method for streaming, a VM executing on a remote computing device, execution from a removable storage device connected to the client (such as universal serial bus (USB) device), etc.

In one or more embodiments, a client (e.g., 110A, 110N, etc.) may include functionality to, e.g.: (i) capture sensory input (e.g., sensor data) in the form of text, audio, video, touch or motion, (ii) collect massive amounts of data at the edge of an Internet of Things (IoT) network (where, the collected data may be grouped as: (a) data that needs no further action and does not need to be stored, (b) data that should be retained for later analysis and/or record keeping, and (c) data that requires an immediate action/response), (iii) provide to other entities (e.g., the IN (120)), store, or otherwise utilize captured sensor data (and/or any other type and/or quantity of data), and (iv) provide surveillance services (e.g., determining object-level information, performing face recognition, etc.) for scenes (e.g., a physical region of space). One of ordinary skill will appreciate that the client may perform other functionalities without departing from the scope of the embodiments disclosed herein.

In one or more embodiments, the clients (e.g., 110A, 110N, etc.) may be geographically distributed devices (e.g., user devices, front-end devices, etc.) and may have relatively restricted hardware and/or software resources when compared to the IN (120). As being, for example, a sensing device, each of the clients may be adapted to provide monitoring services. For example, a client may monitor the state of a scene (e.g., objects disposed in a scene). The monitoring may be performed by obtaining sensor data from sensors that are adapted to obtain information regarding the scene, in which a client may include and/or be operatively coupled to one or more sensors (e.g., a physical device adapted to obtain information regarding one or more scenes).

In one or more embodiments, the sensor data may be any quantity and types of measurements (e.g., of a scene's properties, of an environment's properties, etc.) over any period(s) of time and/or at any points-in-time (e.g., any type of information obtained from one or more sensors, in which different portions of the sensor data may be associated with different periods of time (when the corresponding portions of sensor data were obtained)). The sensor data may be obtained using one or more sensors. The sensor may be, for example (but not limited to): a visual sensor (e.g., a camera adapted to obtain optical information (e.g., a pattern of light scattered off of the scene) regarding a scene/environment), an audio sensor (e.g., a microphone adapted to obtain auditory information (e.g., a pattern of sound from the scene) regarding a scene), an electromagnetic radiation sensor (e.g., an infrared sensor), a chemical detection sensor, a temperature sensor, a humidity sensor, a count sensor, a distance sensor, a global positioning system sensor, a biological sensor, a differential pressure sensor, a corrosion sensor, etc.

In one or more embodiments, the clients (e.g., 110A, 110N, etc.) may be physical or logical computing devices configured for hosting one or more workloads, or for providing a computing environment whereon workloads may be implemented. The clients may provide computing environments that are configured for, at least: (i) workload placement collaboration, (ii) computing resource (e.g., processing, storage/memory, virtualization, networking, etc.) exchange, and (iii) protecting workloads (including their applications and application data) of any size and scale (based on, for example, one or more service level agreements (SLAs) configured by users of the clients). The clients (e.g., 110A, 110N, etc.) may correspond to computing devices that one or more users use to interact with one or more components of the system (100).

In one or more embodiments, a client (e.g., 110A, 110N, etc.) may represent a physical appliance or a computing device operated by one or more individuals of (or employed by) an organization. Examples of said individual(s) may include, but not limited to, any organization executive(s) (e.g., chief executive officer (CEO), chief financial officer (CFO), etc.), and any employee(s) in the accounting/finance team of the organization (e.g., a collector person). Further, the organization may refer to any enterprise at least engaged in for-profit commercial, industrial, or professional activities.

In one or more embodiments, a client (e.g., 110A, 110N, etc.) may include any number of applications (and/or content accessible through the applications) that provide computer-implemented services to a user. Applications may be designed and configured to perform one or more functions instantiated by a user of the client. In order to provide application services, each application may host similar or different components. The components may be, for example (but not limited to): instances of databases, instances of email servers, etc. Applications may be executed on one or more clients as instances of the application.

Applications may vary in different embodiments, but in certain embodiments, applications may be custom developed or commercial (e.g., off-the-shelf) applications that a user desires to execute in a client (e.g., 110A, 110N, etc.). In one or more embodiments, applications may be logical entities executed using computing resources of a client. For example, applications may be implemented as computer instructions stored on persistent storage of the client that when executed by the processor(s) of the client, cause the client to provide the functionality of the applications described throughout the application.

In one or more embodiments, while performing, for example, one or more operations requested by a user, applications installed on a client (e.g., 110A, 110N, etc.) may include functionality to request and use physical and logical resources of the client. Applications may also include functionality to use data stored in storage/memory resources of the client. The applications may perform other types of functionalities not listed above without departing from the scope of the embodiments disclosed herein. While providing application services to a user, applications may store data that may be relevant to the user in storage/memory resources of the client.

In one or more embodiments, to provide services to the users, the clients (e.g., 110A, 110N, etc.) may utilize, rely on, or otherwise cooperate with the IN (120). For example, the clients may issue requests to the IN to receive responses and interact with various components of the IN. The clients may also request data from and/or send data to the IN (for example, the clients may transmit information to the IN that allows the IN to perform computations, the results of which are used by the clients to provide services to the users). As yet another example, the clients may utilize computer-implemented services provided by the IN. When the clients interact with the IN, data that is relevant to the clients may be stored (temporarily or permanently) in the IN.

In one or more embodiments, a client (e.g., 110A, 110N, etc.) may be capable of, e.g.: (i) collecting users' inputs, (ii) correlating collected users' inputs to the computer-implemented services to be provided to the users, (iii) communicating with the IN (120) that perform computations necessary to provide the computer-implemented services, (iv) using the computations performed by the IN to provide the computer-implemented services in a manner that appears (to the users) to be performed locally to the users, and/or (v) communicating with any virtual desktop (VD) in a virtual desktop infrastructure (VDI) environment (or a virtualized architecture) provided by the IN (using any known protocol in the art), for example, to exchange remote desktop traffic or any other regular protocol traffic (so that, once authenticated, users may remotely access independent VDs).

As described above, the clients (e.g., 110A, 110N, etc.) may provide computer-implemented services to users (and/or other computing devices). The clients may provide any number and any type of computer-implemented services. To provide computer-implemented services, each client may include a collection of physical components (e.g., processing resources, storage/memory resources, networking resources, etc.) configured to perform operations of the client and/or otherwise execute a collection of logical components (e.g., virtualization resources) of the client.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a central processing unit (CPU), a graphics processing unit (GPU), a data processing unit (DPU), a computation acceleration resource, an application-specific integrated circuit (ASIC), a digital signal processor for facilitating high speed communication, etc.

In one or more embodiments, a storage or memory resource (not shown) may refer to a measurable quantity of a storage/memory-relevant resource type, which can be requested, allocated, and consumed (for example, to store sensor data and provide previously stored data). A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), a solid-state drive (SSD), random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, etc.

In one or more embodiments, while the clients (e.g., 110A, 110N, etc.) provide computer-implemented services to users, the clients may store data that may be relevant to the users to the storage/memory resources. When the user-relevant data is stored (temporarily or permanently), the user-relevant data may be subjected to loss, inaccessibility, or other undesirable characteristics based on the operation of the storage/memory resources.

To mitigate, limit, and/or prevent such undesirable characteristics, users of the clients (e.g., 110A, 110N, etc.) may enter into agreements (e.g., SLAs) with providers (e.g., vendors) of the storage/memory resources. These agreements may limit the potential exposure of user-relevant data to undesirable characteristics. These agreements may, for example, require duplication of the user-relevant data to other locations so that if the storage/memory resources fail, another copy (or other data structure usable to recover the data on the storage/memory resources) of the user-relevant data may be obtained. These agreements may specify other types of activities to be performed with respect to the storage/memory resources without departing from the scope of the embodiments disclosed herein.

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a network interface card (NIC), a network adapter, a network processor, etc.

In one or more embodiments, a networking resource may provide capabilities to interface a client with external entities (e.g., the IN (120)) and to allow for the transmission and receipt of data with those entities. A networking resource may communicate via any suitable form of wired interface (e.g., Ethernet, fiber optic, serial communication etc.) and/or wireless interface, and may utilize one or more protocols (e.g., transport control protocol (TCP), user datagram protocol (UDP), Remote Direct Memory Access, IEEE 801.11, etc.) for the transmission and receipt of data.

In one or more embodiments, a networking resource may implement and/or support the above-mentioned protocols to enable the communication between the client and the external entities. For example, a networking resource may enable the client to be operatively connected, via Ethernet, using a TCP protocol to form a “network fabric”, and may enable the communication of data between the client and the external entities. In one or more embodiments, each client may be given a unique identifier (e.g., an Internet Protocol (IP) address) to be used when utilizing the above-mentioned protocols.

Further, a networking resource, when using a certain protocol or a variant thereof, may support streamlined access to storage/memory media of other clients (e.g., 110A, 110N, etc.). For example, when utilizing remote direct memory access (RDMA) to access data on another client, it may not be necessary to interact with the logical components of that client. Rather, when using RDMA, it may be possible for the networking resource to interact with the physical components of that client to retrieve and/or transmit data, thereby avoiding any higher-level processing by the logical components executing on that client.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual CPU (vCPU), a virtual storage pool, etc.

In one or more embodiments, a virtualization resource may include a hypervisor (e.g., a VM monitor), in which the hypervisor may be configured to orchestrate an operation of, for example, a VM by allocating computing resources of a client (e.g., 110A, 110N, etc.) to the VM. In one or more embodiments, the hypervisor may be a physical device including circuitry. The physical device may be, for example (but not limited to): a field-programmable gate array (FPGA), an application-specific integrated circuit, a programmable processor, a microcontroller, a digital signal processor, etc. The physical device may be adapted to provide the functionality of the hypervisor. Alternatively, in one or more of embodiments, the hypervisor may be implemented as computer instructions stored on storage/memory resources of the client that when executed by processing resources of the client, cause the client to provide the functionality of the hypervisor.

In one or more embodiments, a client (e.g., 110A, 110N, etc.) may be, for example (but not limited to): a physical computing device, a smartphone, a tablet, a wearable, a gadget, a closed-circuit television (CCTV) camera, a music player, a game controller, etc. Different clients may have different computational capabilities. In one or more embodiments, Client A (110A) may have 16 gigabytes (GB) of dynamic RAM (DRAM) and 1 CPU with 12 cores, whereas Client N (110N) may have 8 GB of PMEM and 1 CPU with 16 cores. Other different computational capabilities of the clients not listed above may also be considered without departing from the scope of the embodiments disclosed herein.

Further, in one or more embodiments, a client (e.g., 110A, 110N, etc.) may be implemented as a computing device (e.g., 400, FIG. 4). The computing device may be, for example, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the client described throughout the application.

Alternatively, in one or more embodiments, the client (e.g., 110A, 110N, etc.) may be implemented as a logical device (e.g., a VM). The logical device may utilize the computing resources of any number of computing devices to provide the functionality of the client described throughout this application.

In one or more embodiments, users (e.g., customers, administrators, organization executives, etc.) may interact with (or operate) the clients (e.g., 110A, 110N, etc.) in order to perform work-related tasks (e.g., production workloads). In one or more embodiments, the accessibility of users to the clients may depend on a regulation set by an administrator of the clients. To this end, each user may have a personalized user account that may, for example, grant access to certain data, applications, and computing resources of the clients. This may be realized by implementing the virtualization technology. In one or more embodiments, an administrator may be a user with permission (e.g., a user that has root-level access) to make changes on the clients that will affect other users of the clients.

In one or more embodiments, for example, a user may be automatically directed to a login screen of a client when the user connected to that client. Once the login screen of the client is displayed, the user may enter credentials (e.g., username, password, etc.) of the user on the login screen. The login screen may be a graphical user interface (GUI) generated by a visualization module (not shown) of the client. In one or more embodiments, the visualization module may be implemented in hardware (e.g., circuitry), software, or any combination thereof.

In one or more embodiments, a GUI may be displayed on a display of a computing device (e.g., 400, FIG. 4) using functionalities of a display engine (not shown), in which the display engine is operatively connected to the computing device. The display engine may be implemented using hardware (or a hardware component), software (or a software component), or any combination thereof. The login screen may be displayed in any visual format that would allow the user to easily comprehend (e.g., read and parse) the listed information.

In one or more embodiments, the IN (120) may include (i) a chassis (e.g., a mechanical structure, a rack mountable enclosure, etc.) configured to house one or more servers (or blades) and their components and (ii) any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

In one or more embodiments, the IN (120) may include functionality to, e.g.: (i) obtain (or receive) data (e.g., any type and/or quantity of input) from any source (and, if necessary, aggregate the data); (ii) perform complex analytics and analyze data that is received from one or more clients (e.g., 110A, 110N, etc.) to generate additional data that is derived from the obtained data without experiencing any middleware and hardware limitations; (iii) provide meaningful information (e.g., a response) back to the corresponding clients; (iv) filter data (e.g., received from a client) before pushing the data (and/or the derived data) to the database (135) for management of the data and/or for storage of the data (while pushing the data, the IN may include information regarding a source of the data (e.g., an identifier of the source) so that such information may be used to associate provided data with one or more of the users (or data owners)); (v) host and maintain various workloads; (vi) provide a computing environment whereon workloads may be implemented (e.g., employing linear, non-linear, and/or ML models to perform cloud-based data processing); (vii) incorporate strategies (e.g., strategies to provide VDI capabilities) for remotely enhancing capabilities of the clients; (viii) provide robust security features to the clients and make sure that a minimum level of service is always provided to a user of a client; (ix) transmit the result(s) of the computing work performed (e.g., real-time business insights, equipment maintenance predictions, other actionable responses, etc.) to another IN (not shown) for review and/or other human interactions; (x) exchange data with other devices registered in/to the network (130) in order to, for example, participate in a collaborative workload placement (e.g., the node may split up a request (e.g., an operation, a task, an activity, etc.) with another IN, coordinating its efforts to complete the request more efficiently than if the IN had been responsible for completing the request); (xi) provide software-defined data protection for the clients (e.g., 110A, 110N, etc.); (xii) provide automated data discovery, protection, management, and recovery operations for the clients; (xiii) monitor operational states of the clients; (xiv) regularly back up configuration information of the clients to the database (135); (xv) provide (e.g., via a broadcast, multicast, or unicast mechanism) information (e.g., a location identifier, the amount of available resources, etc.) associated with the IN to other INs of the system (100); (xvi) configure or control any mechanism that defines when, how, and what data to provide to the clients and/or database; (xvii) provide data deduplication; (xviii) orchestrate data protection through one or more GUIs; (xix) empower data owners (e.g., users of the clients) to perform self-service data backup and restore operations from their native applications; (xx) ensure compliance and satisfy different types of service level objectives (SLOs) set by an administrator/user; (xxi) increase resiliency of an organization by enabling rapid recovery or cloud disaster recovery from cyber incidents; (xxii) provide operational simplicity, agility, and flexibility for physical, virtual, and cloud-native environments; (xxiii) consolidate multiple data process or protection requests (received from, for example, clients) so that duplicative operations (which may not be useful for restoration purposes) are not generated; (xxiv) initiate multiple data process or protection operations in parallel (e.g., an IN may host multiple operations, in which each of the multiple operations may (a) manage the initiation of a respective operation and (b) operate concurrently to initiate multiple operations); and/or (xxv) manage operations of one or more clients (e.g., receiving information from the clients regarding changes in the operation of the clients) to improve their operations (e.g., improve the quality of data being generated, decrease the computing resources cost of generating data, etc.). In one or more embodiments, in order to read, write, or store data, the IN (120) may communicate with, for example, the database (135) and/or other storage devices in the system (100).

As described above, the IN (120) may be capable of providing a range of functionalities/services to the users of the clients (e.g., 110A, 110N, etc.). However, not all users may be allowed to receive all of the services. To manage the services provided to the users of the clients, a system (e.g., a service manager) in accordance with embodiments disclosed herein may manage the operation of a network (e.g., 130), in which the clients are operably connected to the IN. Specifically, the service manager (i) may identify services to be provided by the IN (for example, based on the number of users using the clients) and (ii) may limit communications of the clients to receive IN provided services.

For example, the priority (e.g., the user access level) of a user may be used to determine how to manage computing resources of the IN (120) to provide services to that user. As yet another example, the priority of a user may be used to identify the services that need to be provided to that user. As yet another example, the priority of a user may be used to determine how quickly communications (for the purposes of providing services in cooperation with the internal network (and its subcomponents)) are to be processed by the internal network.

Further, consider a scenario where a first user is to be treated as a normal user (e.g., a non-privileged user, a user with a user access level/tier of 4/10). In such a scenario, the user level of that user may indicate that certain ports (of the subcomponents of the network (130) corresponding to communication protocols such as the TCP, the UDP, etc.) are to be opened, other ports are to be blocked/disabled so that (i) certain services are to be provided to the user by the IN (120) (e.g., while the computing resources of the IN may be capable of providing/performing any number of remote computer-implemented services, they may be limited in providing some of the services over the network (130)) and (ii) network traffic from that user is to be afforded a normal level of quality (e.g., a normal processing rate with a limited communication bandwidth (BW)). By doing so, (i) computer-implemented services provided to the users of the clients (e.g., 110A, 110N, etc.) may be granularly configured without modifying the operation(s) of the clients and (ii) the overhead for managing the services of the clients may be reduced by not requiring modification of the operation(s) of the clients directly.

In contrast, a second user may be determined to be a high priority user (e.g., a privileged user, a user with a user access level of 9/10). In such a case, the user level of that user may indicate that more ports are to be opened than were for the first user so that (i) the IN (120) may provide more services to the second user and (ii) network traffic from that user is to be afforded a high-level of quality (e.g., a higher processing rate than the traffic from the normal user).

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): a data protection workload, a VM, a container, a network-attached storage (NAS), a database, an application, a collection of microservices, a file system (FS), small workloads with lower priority workloads (e.g., FS host data, operating system (OS) data, etc.), medium workloads with higher priority (e.g., VM with FS data, network data management protocol (NDMP) data, etc.), large workloads with critical priority (e.g., mission critical application data), etc.

Further, while a single IN (e.g., 120) is considered above, the term “node” includes any collection of systems or sub-systems that individually or jointly execute a set, or multiple sets, of instructions to provide one or more computer-implemented services. For example, a single IN may provide a computer-implemented service on its own (i.e., independently) while multiple other nodes may provide a second computer-implemented service cooperatively (e.g., each of the multiple other nodes may provide similar and or different services that form the cooperatively provided service).

As described above, the IN (120) may provide any quantity and any type of computer-implemented services. To provide computer-implemented services, the IN may be a heterogeneous set, including a collection of physical components/resources (discussed above) configured to perform operations of the node and/or otherwise execute a collection of logical components/resources (discussed above) of the node.

In one or more embodiments, the IN (120) may implement a management model to manage the aforementioned computing resources in a particular manner. The management model may give rise to additional functionalities for the computing resources. For example, the management model may automatically store multiple copies of data in multiple locations when a single write of the data is received. By doing so, a loss of a single copy of the data may not result in a complete loss of the data. Other management models may include, for example, adding additional information to stored data to improve its ability to be recovered, methods of communicating with other devices to improve the likelihood of receiving the communications, etc. Any type and number of management models may be implemented to provide additional functionalities using the computing resources without departing from the scope of the embodiments disclosed herein.

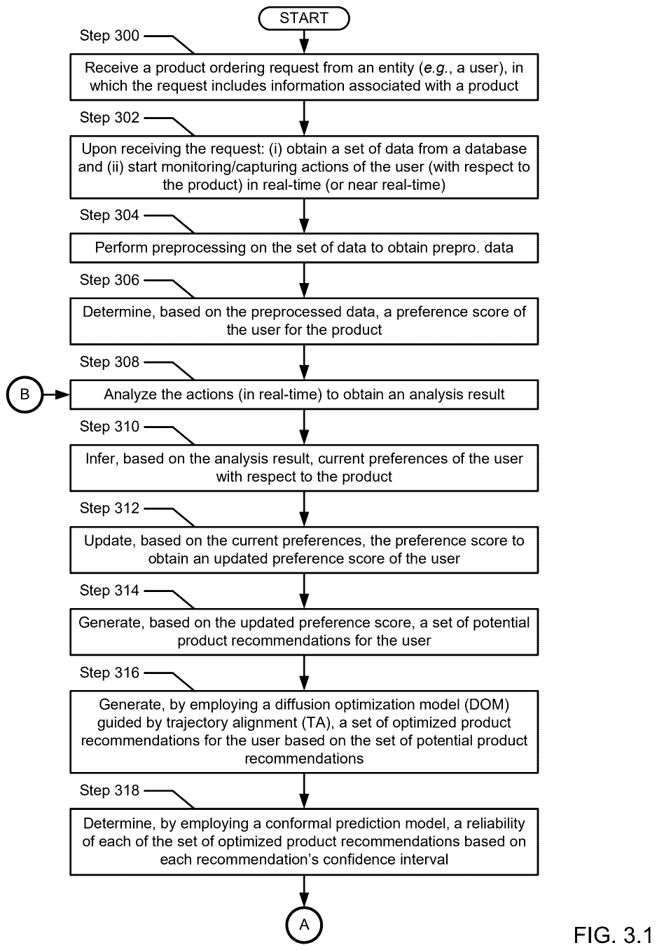

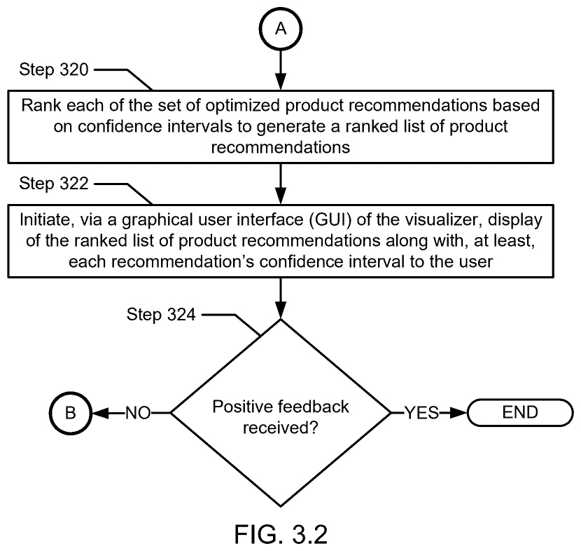

One of ordinary skill will appreciate that the IN (120) may perform other functionalities without departing from the scope of the embodiments disclosed herein. In one or more embodiments, the IN may be configured to perform (in conjunction with the database (135)) all, or a portion, of the functionalities described in FIGS. 3.1-3.2.

In one or more embodiments, the IN (120) may be implemented as a computing device (e.g., 400, FIG. 4). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the IN described throughout the application.

Alternatively, in one or more embodiments, similar to a client (e.g., 110A, 110N, etc.), the IN (120) may also be implemented as a logical device.

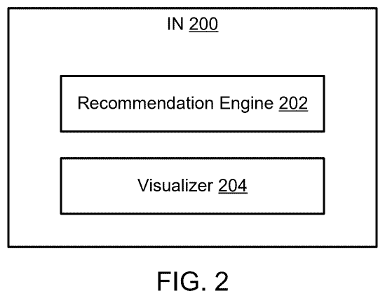

In one or more embodiments, the IN (120) may host a recommendation engine (e.g., 202, FIG. 2) and a visualizer (e.g., 204, FIG. 2). Additional details of the recommendation engine and the visualizer are described below in reference to FIG. 2. In the embodiments of the present disclosure, the database (135) is demonstrated as a separate entity from the IN (120); however, embodiments disclosed herein are not limited as such. The database (135) may be demonstrated as a part of the IN (e.g., as deployed to the IN).

In one or more embodiments, all, or a portion, of the components of the system (100) may be operably connected each other and/or other entities via any combination of wired and/or wireless connections. For example, the aforementioned components may be operably connected, at least in part, via the network (130). Further, all, or a portion, of the components of the system (100) may interact with one another using any combination of wired and/or wireless communication protocols.

In one or more embodiments, the network (130) may represent a (decentralized or distributed) computing network and/or fabric configured for computing resource and/or messages exchange among registered computing devices (e.g., the clients, the IN, etc.). As discussed above, components of the system (100) may operatively connect to one another through the network (e.g., a storage area network (SAN), a personal area network (PAN), a LAN, a metropolitan area network (MAN), a WAN, a mobile network, a wireless LAN (WLAN), a virtual private network (VPN), an intranet, the Internet, etc.), which facilitates the communication of signals, data, and/or messages. In one or more embodiments, the network (130) may be implemented using any combination of wired and/or wireless network topologies, and the network may be operably connected to the Internet or other networks. Further, the network (130) may enable interactions between, for example, the clients and the IN through any number and type of wired and/or wireless network protocols (e.g., TCP, UDP, IPv4, etc.).

The network (130) may encompass various interconnected, network-enabled subcomponents (not shown) (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The network (130) and its subcomponents may be implemented using hardware, software, or any combination thereof.

In one or more embodiments, before communicating data over the network (130), the data may first be broken into smaller batches (e.g., data packets) so that larger size data can be communicated efficiently. For this reason, the network-enabled subcomponents may break data into data packets. The network-enabled subcomponents may then route each data packet in the network (130) to distribute network traffic uniformly.

In one or more embodiments, the network-enabled subcomponents may decide how real-time (e.g., on the order of ms or less) network traffic and non-real-time network traffic should be managed in the network (130). In one or more embodiments, the real-time network traffic may be high-priority (e.g., urgent, immediate, etc.) network traffic. For this reason, data packets of the real-time network traffic may need to be prioritized in the network (130). The real-time network traffic may include data packets related to, for example (but not limited to): videoconferencing, web browsing, voice over Internet Protocol (VOIP), etc.

Turning now to the database (135), the database (135) may provide long-term, durable, high read/write throughput data storage/protection with near-infinite scale and low-cost. The database (135) may be a fully managed cloud/remote (or local) storage (e.g., pluggable storage, object storage, block storage, file system storage, data stream storage, Web servers, unstructured storage, etc.) that acts as a shared storage/memory resource that is functional to store unstructured and/or structured data. Further, the database (135) may also occupy a portion of a physical storage/memory device or, alternatively, may span across multiple physical storage/memory devices.

In one or more embodiments, the database (135) may be implemented using physical devices that provide data storage services (e.g., storing data and providing copies of previously stored data). The devices that provide data storage services may include hardware devices and/or logical devices. For example, the database (135) may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the database (135) may include a memory device (e.g., a dual in-line memory device), in which data is stored and from which copies of previously stored data are provided. As yet another example, the database (135) may include a persistent storage device (e.g., an SSD), in which data is stored and from which copies of previously stored data is provided. As yet another example, the database (135) may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, the database (135) may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, the database (135) may store/record unstructured and/or structured data that may include (or specify), for example (but not limited to): an identifier of a user/customer (e.g., a unique string or combination of bits associated with a particular user); a request received from a user (or a user's account); a geographic location (e.g., a country) associated with the user; a timestamp showing when a specific request is processed by an application; a port number (e.g., associated with a hardware component of a client (e.g., 110A)); a protocol type associated with a port number; computing resource details (including details of hardware components and/or software components) and an IP address of an IN (e.g., 120) hosting an application where a specific request is processed; an identifier of an application; information with respect to historical metadata (e.g., system logs, applications logs, telemetry data including past and present device usage of one or more computing devices in the system (100), etc.); computing resource details and an IP address of a client that sent a specific request (e.g., to the IN (120)); one or more points-in-time and/or one or more periods of time associated with a data recovery event; data for execution of applications/services (including IN applications and associated end-points); corpuses of annotated data used to build/generate and train processing classifiers for trained ML models; linear, non-linear, and/or ML model parameters (e.g., instructions to the recommendation engine (e.g., 202, FIG. 2) on how to train and/or fine-tune a model); an identifier of a sensor; a product identifier of a client (e.g., 110A); a type of a client; historical sensor data/input (e.g., visual sensor data, audio sensor data, electromagnetic radiation sensor data, temperature sensor data, humidity sensor data, corrosion sensor data, etc., in the form of text, audio, video, touch, and/or motion) and its corresponding details; an identifier of a data item; a size of the data item; a distributed model identifier that uniquely identifies a distributed model; a user activity performed on a data item; a cumulative history of user/administrator activity records obtained over a prolonged period of time; a setting (and a version) of a mission critical application executing on an IN (e.g., 120); an SLA/SLO set by a user; a data protection policy (e.g., an affinity-based backup policy) implemented by a user (e.g., to protect a local data center, to perform a rapid recovery, etc.); a configuration setting of that policy; product configuration information associated with a client; a number of each type of a set of assets protected by an IN (e.g., 120); a size of each of the set of assets protected; a number of each type of a set of data protection policies implemented by a user; configuration information associated with the recommendation engine (e.g., 202, FIG. 2) (to manage security, network traffic, network access, or any other function/operation performed by the engine); a job detail of a job (e.g., a data protection job, a data restoration job, a log retention job, etc.) that has been initiated by an IN (e.g., 120); a type of the job (e.g., a non-parallel processing job, a parallel processing job, an analytics job, etc.); information associated with a hardware resource set (discussed below) of the IN (120) and/or a product (e.g., a computing device); a completion timestamp encoding a date and/or time reflective of a successful completion of a job; a time duration reflecting the length of time expended for executing and completing a job; a backup retention period associated with a data item; a status of a job (e.g., how many jobs are still active, how many jobs are completed, etc.); a number of requests handled (in parallel) per minute (or per second, per hour, etc.) by the analyzer; a number of errors encountered when handling a job; a documentation that shows how the analyzer performs against an SLO and/or an SLA; information regarding an administrator (e.g., a high-priority trusted administrator, a low-priority trusted administrator, etc.) related to an analytics job; a workflow (e.g., a policy that dictates how a workload should be configured and/or protected, such as an SQL workflow dictates how an SQL workload should be protected) set (by a user); a type of a workload that is tested/validated by an administrator per data protection policy; a practice recommended by a vendor (e.g., a single data protection policy should not protect more than 100 assets; for a dynamic NAS, maximum one billion files can be protected per day, etc.); one or more device state paths corresponding to a hardware device (e.g., a client); an existing knowledge base (KB) article; a technical support history documentation of a customer/user; a port's user guide; a port's release note; a community forum question and its associated answer; a catalog file of an application upgrade; details of a compatible OS version for an application upgrade to be installed; an application upgrade sequence; a solution or a workaround document for a software failure; one or more lists that specify which computer-implemented services should be provided to which user (depending on a user access level of a user); a fraud report for an invalid user; a set of SLAs (e.g., an agreement that indicates a period of time required to retain a profile of a user); information with respect to a user/customer experience about a product/service; information related to a product (e.g., a purchase order number of a product, a shipping address of a user/customer, a billing address of the customer, a unit price of a hardware component (of the product), a setting of an application, a version of the application, a version of an OS, display resolution configuration of the product, an amount of storage available in the product, a language setting of the OS, a serial number of the product, media access control (MAC) information of the product, hardware resource set information of the product, an identifier of a vendor that provides the product, etc.); etc.

In one or more embodiments, information associated with a hardware resource set (e.g., including at least resource related parameters) may specify, for example (but not limited to): a configurable CPU option (e.g., a valid/legitimate vCPU count per IN in the system (100)), a configurable network resource option (e.g., enabling/disabling single-root input/output virtualization (SR-IOV) for the IN (120)), a configurable memory option (e.g., maximum and minimum memory per IN in the system (100)), a configurable GPU option (e.g., allowable scheduling policy and/or virtual GPU (vGPU) count combinations per IN in the system (100)), a configurable DPU option (e.g., legitimacy of disabling inter-integrated circuit (12C) for various INs in the system (100)), a configurable storage space option (e.g., a list of disk cloning technologies across one or more INs in the system (100)), a configurable storage input/output (I/O) option (e.g., a list of possible file system block sizes across all target file systems), a user type (e.g., a knowledge worker, a task worker with relatively low-end compute requirements, a high-end user that requires a rich multimedia experience, etc.), a network resource related template (e.g., a 10 GB/s BW with 20 ms latency quality of service (QoS) template), a DPU related template (e.g., a 1 GB/s BW vDPU with 1 GB vDPU frame buffer template), a GPU related template (e.g., a depth-first vGPU with 1 GB vGPU frame buffer template), a storage space related template (e.g., a 40 GB SSD storage template), a CPU related template (e.g., a 1 vCPU with 4 cores template), a memory resource related template (e.g., an 8 GB DRAM template), a vCPU count per analytics engine, a virtual NIC (vNIC) count per IN in the system (100), a wake on LAN support configuration (e.g., supported/enabled, not supported/disabled, etc.), a vGPU count per IN in the system (100), a type of a vGPU scheduling policy (e.g., a “fixed share” vGPU scheduling policy), a storage mode configuration (e.g., an enabled high-performance storage array mode), etc.

In one or more embodiments, as being telemetry data, a system log (e.g., a file that records system activities across hardware and/or software components of a client, an internal lifecycle controller log (which may be generated as a result of internal testing of a NIC), etc.) may include (or specify), for example (but not limited to): a type of an asset (e.g., a type of a workload such as an SQL database, a NAS executing on-premises, a VM executing on a multi-cloud infrastructure, etc.) that is utilized by a user; computing resource utilization data (or key performance metrics including estimates, measurements, etc.) (e.g., data related to a user's maximum, minimum, and average CPU utilizations, an amount of storage or memory resource utilized by a user, an amount of networking resource utilized by user to perform a network operation, etc.) regarding computing resources of a client (e.g., 110A); an alert that is triggered in a client (e.g., based on a failed cloud disaster recovery operation (which is initiated by a user), the client may generate a failure alert); an important keyword associated with a hardware component of a client (e.g., recommended maximum CPU operating temperature is 75° C.); a computing functionality of a microservice (e.g., Microservice A's CPU utilization is 26%, Microservice B's GPU utilization is 38%, etc.); an amount of storage or memory resource (e.g., stack memory, heap memory, cache memory, etc.) utilized by a microservice (e.g., executing on a client); a certain file operation performed by a microservice; an amount of networking resource utilized by a microservice to perform a network operation (e.g., to publish and coordinate inter-process communications); an amount of bare metal communications executed by a microservice (e.g., I/O operations executed by the microservice per second); a quantity of threads (e.g., a term indicating the quantity of operations that may be handled by a processor at once) utilized by a process that is executed by a microservice; an identifier of a client's manufacturer; MAC information of a client; an amount of bare metal communication executed by a client (e.g., I/O operations executed by a client per second); etc.

In one or more embodiments, an alert (e.g., a predictive alert, a proactive alert, a technical alert, etc.) may be defined by a vendor of a corresponding client (e.g., 110A), by an administrator, by another entity, or any combination thereof. In one or more embodiments, an alert may specify, for example (but not limited to): a medium-level of CPU overheating is detected, a recommended maximum CPU operating temperature is exceeded, etc. Further, an alert may be defined based on a data protection policy.

In one or more embodiments, an important keyword may be defined by a vendor of a corresponding client (e.g., 110A), by a technical support specialist, by the administrator, by another entity, or any combination thereof. In one or more embodiments, an important keyword may be a specific technical term or a vendor specific term that is used in a system log.

In one or more embodiments, as being telemetry data, an application log may include (or specify), for example (but not limited to): a type of a file system (e.g., a new technology file system (NTFS), a resilient file system (ReFS), etc.); a product identifier of an application; a version of an OS that an application is executing on; a display resolution configuration of a client; a health status of an application (e.g., healthy, unhealthy, etc.); warnings and/or errors reported for an application; a language setting of an OS; a setting of an application (e.g., a current setting that is being applied to an application either by a user or by default, in which the setting may be a font option that is selected by the user, a background setting of the application, etc.); a version of an application; a warning reported for an application (e.g., unknown software exception (0xc00d) occurred in the application at location 0x0007d); a type of an OS (e.g., a workstation OS); an amount of storage used by an application; a size of an application (size (e.g., 5 Megabytes (5 MB), 5 GB, etc.) of an application may specify how much storage space is being consumed by that application); a type of an application (a type of an application may specify that, for example, the application is a support, deployment, or recycling application); a priority of an application (e.g., a priority class of an application, described below); active and inactive session counts; etc.

As used herein, “unhealthy” may refer to a compromised health state (e.g., an unhealthy state), indicating a corresponding entity (e.g., a hardware component, a client, an application, etc.) has already or is likely to, in the future, be no longer able to provide the services that the entity has previously provided. The health state determination may be made via any method based on the aggregated health information without departing from the scope of the embodiments disclosed herein.

In one or more embodiments, metadata (e.g., system logs, application logs, etc.) may be obtained (or dynamically fetched) as they become available (e.g., with no user manual intervention), or by the recommendation engine (e.g., 202, FIG. 2) polling a corresponding client (e.g., 110A) (by making schedule-driven/periodic application programming interface (API) calls to the client without affecting the client's ongoing production workloads) for newer metadata, for example, before analyzing a health state of the client. Based on receiving the API calls from the recommendation engine, the client may allow the recommendation engine to obtain the metadata.

In one or more embodiments, the metadata may be obtained (or streamed) continuously as they generated, or they may be obtained in batches, for example, in scenarios where (i) the recommendation engine (e.g., 202, FIG. 2) receives a metadata analysis request (or a health state check request for a client), (ii) another IN of the system (100) accumulates the metadata and provides them to the engine at fixed time intervals, or (iii) the database (135) stores the metadata and notify the recommendation engine to access the metadata from the database. In one or more embodiments, metadata may be access-protected for a transmission from the database (135) to the recommendation engine (e.g., 202, FIG. 2), e.g., using encryption.

While the unstructured and/or structured data are illustrated as separate data structures and have been discussed as including a limited amount of specific information, any of the aforementioned data structures may be divided into any number of data structures, combined with any number of other data structures, and/or may include additional, less, and/or different information without departing from the scope of the embodiments disclosed herein.

Additionally, while illustrated as being stored in the database (135), any of the aforementioned data structures may be stored in different locations (e.g., in persistent storage of other computing devices) and/or spanned across any number of computing devices without departing from the scope of the embodiments disclosed herein.

In one or more embodiments, the unstructured and/or structured data may be updated (automatically) by third-party systems (e.g., platforms, marketplaces, etc.) (provided by vendors) and/or by the administrators based on, for example, newer (e.g., updated) versions of external information. The unstructured and/or structured data may also be updated when, for example (but not limited to): newer system logs are received, a state of the recommendation engine (e.g., 202, FIG. 2) is changed, etc.

While the database (135) has been illustrated and described as including a limited number and type of data, the database (135) may store additional, less, and/or different data without departing from the scope of the embodiments disclosed herein. One of ordinary skill will appreciate that the database (135) may perform other functionalities without departing from the scope of the embodiments disclosed herein.

While FIG. 1 shows a configuration of components, other system configurations may be used without departing from the scope of the embodiments disclosed herein.

Turning now to FIG. 2, FIG. 2 shows a diagram of an IN (200) in accordance with one or more embodiments disclosed herein. The IN (200) may be an example of the IN discussed above in reference to FIG. 1. The IN (200) includes the recommendation engine (202) and the visualizer (204), which may form the framework (discussed above). The IN (200) may include additional, fewer, and/or different components without departing from the scope of the embodiments disclosed herein. Each component may be operably connected to any of the other component via any combination of wired and/or wireless connections. Each component illustrated in FIG. 2 is discussed below.

In one or more embodiments, the recommendation engine (202) may include functionality to implement the DPO approach, as being part of the framework, which represents a major advancement in the domain of recommendation systems. The DPO approach is a method that enables the recommendation engine (202) to learn directly from user preferences in real-time, without the computational complexity and overhead typically associated with RL methods.

In one or more embodiments, unlike traditional RL methods that require explicit reward functions and complex policy optimization, the DPO approach optimizes a recommendation model(s) (e.g., a set of linear, non-linear, and/or ML models, employed by the recommendation engine (202)) by learning from user preferences (e.g., actions, interactions, feedback, etc.). This learning approach ensures that the recommendation engine (202) dynamically adapts its recommendations based on direct feedback from users, making the recommendations more personalized and relevant.

In one or more embodiments, the DPO approach leverages a more straightforward optimization process (for the recommendation engine (202)), eliminating the need for sampling from large policy spaces or performing extensive hyperparameter tuning. This efficiency is particularly beneficial for real-time applications, in which the ability to quickly adjust recommendations based on user interactions is crucial.

Further, by focusing on user preferences, the DPO approach enables the recommendation engine (202) to perform a more user-centric recommendation generation process. This means that as users interact with the recommendation engine (202) via the visualizer (204), by adding or removing products from their quote, for example, the recommendation engine may immediately adjust its recommendations to better match the users' evolving needs and preferences.

As indicated above, the DPO approach is foundational to the recommendation engine's (202) ability to provide dynamic, real-time recommendations. The DPO approach ensures that the recommendation engine (202) remains highly responsive to user actions, significantly enhancing the user experience. By eliminating the complexity associated with RL methods, the DPO approach contributes to the recommendation engine's (202) overall computational efficiency. This simplification allows the recommendation engine (202) to operate with reduced computational resources while still delivering high-quality recommendations. The direct learning from user preferences, via the DPO approach, enables the recommendation engine (202) to provide highly personalized recommendations, which is key to improving user satisfaction and engagement with the framework.

In one or more embodiments, as being a core component of the framework, the DPO approach (e.g., the streamlined, efficient, and user-centric approach) enables the recommendation engine (202) to generate dynamic product recommendations. The implementation of the DPO approach (by the recommendation engine (202)) represents a novel approach to overcoming the limitations of traditional recommendation engines, particularly in terms of real-time adaptability and computational efficiency. Additional details of the DPO approach are discussed below.

In one or more embodiments, the recommendation engine (202) may further include functionality to implement the DOM with the TA methodology, as being part of the framework (or as being a core component of the framework), in which the DOM with the TA methodology combines the principles of diffusion-based generative models with TA techniques to enhance a recommendation process' (performed by the recommendation engine (202)) efficiency, accuracy, and relevance.

At its core, the DOM utilizes diffusion processes for generating recommendations. These models (e.g., the diffusion optimization models) may start with a random distribution and iteratively refine the distribution towards generating product (and/or service) recommendations that align with user preferences and constraints. The DOM allows the recommendation engine (202) for exploring a vast space of possible recommendations, ensuring that the generated suggestions are both diverse and pertinent (e.g., to user preferences).

Further, the TA methodology is a technique that aligns the generative process of the DOM with optimization trajectories (e.g., of a related organization). This alignment ensures that the path(s) taken by the DOM (or, indirectly, by the recommendation engine (202)) during the generation of recommendations are informed by optimization goals (of the organization), such as maximizing margins or aligning with specific user preferences. By incorporating knowledge from previous optimization successes, the TA technique guides the DOM (or, indirectly, by the recommendation engine (202)) towards more effective and relevant recommendation generation.

As indicated above, the DOM, powered by the TA technique, enables the generation of recommendations (by the recommendation engine (202)) that are not only relevant to the current user context/preferences but also diverse, offering users a broader range of choices that align with their preferences and the sales context (e.g., of the related organization). The iterative nature of diffusion processes, combined with the TA technique, allows the recommendation engine (202) to adapt/modify its recommendations in real-time. This adaptability is crucial for responding to changes in user preferences or quote details during the recommendation generation process.

Further, by leveraging the inherent efficiency of diffusion models and the directed focus of the TA technique, the recommendation engine (202) may efficiently handle large-scale recommendation tasks. This efficiency does not compromise the quality or relevance of the recommendations, making the recommendation engine (202) scalable to various industries and application scenarios. The integration of the TA technique ensures that the recommendations are not only aligned with user preferences but also with strategic objectives of organizations. This alignment (managed by the recommendation engine (202)) is achieved by guiding the diffusion processes towards product combinations that enhance profitability while meeting user needs.

In one or more embodiments, by employing the DOM with the TA methodology, the recommendation engine (202) may combine the exploratory power of diffusion models with the goal-directed precision of the TA, resulting in a framework that is adaptable, efficient, and aligned with both user preferences and objectives of organizations. This approach is instrumental in overcoming the limitations of traditional recommendation systems, especially in providing more dynamic, relevant, and strategically focused recommendations to users. Additional details of the DOM with the TA methodology are described below.

In one or more embodiments, the recommendation engine (202) may further include functionality to implement conformal prediction techniques, as being part of the framework (or as being a core component of the framework), in which conformal prediction is a statistical approach that provides valid, model-agnostic uncertainty quantification for predictions made by ML models (e.g., employed by the recommendation engine).

In one or more embodiments, conformal prediction techniques (employed by the recommendation engine (202)) offer a systematic way to quantify the uncertainty associated with each recommendation. By generating confidence intervals (or p-values) for predictions, the recommendation engine (202) may inform users about the reliability and potential variability of recommendations (e.g., related to products, services, and/or any combinations thereof). Further, with quantifiable measures of confidence (with respect to provided recommendations), salespeople and/or end-users (e.g., users, customer, etc.) may be empowered to make more informed decisions. Confidence scores/intervals can guide users in navigating through recommendations (e.g., recommended options provided by the recommendation engine (202)), prioritizing recommendations that not only meet their needs but also have a high likelihood of success and/or customer satisfaction.

In one or more embodiments, in the context of margin optimization, conformal prediction techniques (employed by the recommendation engine (202)) can adjust recommendations to not just maximize profitability (of a related organization) but do so with a quantifiable level of confidence. This ensures that strategic recommendations (generated by the recommendation engine (202)) align with objectives of the organization while maintaining a transparent and trustworthy decision-making process (for the users).

As indicated above, by integrating/employing conformal prediction techniques, the recommendation engine (202) may align, for example, product recommendations with goals of an organization under the structure of statistical confidence. This alignment is crucial for recommendations that aim to optimize margins, ensuring that recommended products/services (by the recommendation engine (202)) are both preferred by customers and beneficial to the organization's goals. The recommendation engine (202) may enhance trust and reliability in its recommendations by providing a statistical measure of confidence (with the help of conformal prediction techniques), in which users can assess the robustness of each recommendation, contributing to a transparent and trustworthy user experience.

In one or more embodiments, conformal prediction techniques may complement the recommendation engine's (202) dynamic nature by allowing real-time adjustment of confidence levels based on changing data inputs and user interactions. This adaptability is key to maintaining relevant and reliable recommendations, for example, throughout a product sales process. By quantifying the uncertainty of recommendations (with the help of the conformal prediction techniques), the recommendation engine (202) offers a form of risk management, enabling users to weigh the potential benefits of a recommendation against its uncertainty. This feature is particularly valuable in high-stakes decision-making environments, in which reliable, strategically aligned, and dynamically adaptable recommendations are needed (which are provided by the recommendation engine (202)). Additional details of the conformal prediction techniques are discussed below.

In one or more embodiments, the recommendation engine (202) may leverage the DPO approach, the DOM with the TA methodology, and conformal prediction techniques to overcome issues with traditional recommendation systems. By integrating these methodologies/approaches, the recommendation engine (202) may generate real-time, personalized, and margin-optimized product/service recommendations. In one or more embodiments, the functionalities provided by the recommendation engine (202) not only addresses the computational inefficiency and scalability issues (of traditional recommendation systems) but also ensures that the recommendations are strategically aligned with objectives of a related organization and backed by quantifiable measures of confidence.

As discussed above, the recommendation engine (202): (i) employs the DPO approach to adapt recommendations based on real-time user interactions and preferences dynamically (in which this approach allows the recommendation engine to generate personalized and contextually relevant recommendations without the computational overhead of RL techniques), (ii) leverages the DOM with the TA methodology to efficiently generate high-quality recommendations from sparse data (in which the DOM utilizes diffusion processes to explore possible recommendations, while the TA methodology ensures that the recommendation generation process (performed by the recommendation engine) is informed by optimization goals (of a related organization) (this combination not only enhances the relevance and diversity of recommendations but also significantly improves computational efficiency of the recommendation engine)), and (iii) to quantify the uncertainty of each recommendation and align recommendations with objectives of a related organization, incorporates conformal prediction techniques (in which these techniques may provide valid, model-agnostic confidence measures for the recommendations, enabling transparent and informed decision-making that accounts for risk management and strategic goal alignment).

In one or more embodiments, as an initial step (see Steps 302 and 304 of FIG. 3.1), the recommendation engine (202) may perform two main phases: collection of a set of data and preprocessing of the set of data, each critical for ensuring the recommendation engine (202) has a robust foundation for data analysis and recommendation generation.

In one or more embodiments, the data collection phase may involve gathering a comprehensive set of data (e.g., from the database (e.g., 135, FIG. 1)) that will inform the recommendation engine (202). In one or more embodiments, the set of data may include (or specify), for example (but not limited to): historical sales data (e.g., information on previous purchases, which may help in identifying customer purchasing trends and popular products/services), customer/user preferences and interactions (e.g., data on customer interactions with the framework, such as browsing history, product views, adds to cart, removals from the cart, etc., in which this data may be vital for understanding individual customer preferences), product information (e.g., detailed descriptions of products, including categories, specifications, prices, and any other attributes relevant to generating recommendations), margin details (e.g., information with respect to margin or profitability associated with each product, in which this information is crucial for ensuring that the recommendations align with objectives (e.g., maximizing profits) of a related organization), information obtained from external data sources (e.g., depending on the industry, information from external data sources (e.g., market trends, seasonal demand fluctuations, competitive pricing, etc.) may also be considered to enrich the recommendation engine's (202) insights), etc.

Once collected/obtained, the set of data may undergo a preprocessing phase (see Step 304 of FIG. 3.1), performed by the recommendation engine (202), to ensure that the set of data is clean, structured, and ready for further analysis. In one or more embodiments, preprocessing of the set of data may include, for example (but not limited to): (i) data cleaning (identifying and addressing missing values, removing duplicates, and correcting inconsistencies in the data to ensure its quality and reliability), (ii) normalization (standardizing data formats, especially when dealing with data from multiple sources, to ensure uniformity, in which this may involve converting text to lowercase, standardizing date formats, or scaling numerical values), (iii) feature extraction (deriving meaningful features from the raw data that will be used in the recommendation generation process (e.g., parsing product descriptions to extract key features (e.g., a category of a product, information with respect to a hardware resource set of the product, cost of the product,) or analyzing historical sales data to identify purchasing patterns of customers, etc.), (iv) categorization and tagging (organizing products into categories or tagging them with relevant attributes to facilitate targeted recommendations, which may also involve classifying customer behavior patterns to segment users effectively), (v) data integration (consolidating all collected and processed data into a cohesive dataset that can be easily accessed and utilized by the recommendation engine (202)), etc.

In one or more embodiments, the meticulous execution of data collection and preprocessing ensures that the recommendation engine (202) has a solid foundation of high-quality, relevant data. This step is crucial for enabling the recommendation engine (202) to generate accurate, personalized, and margin-optimized product recommendations.

As discussed above, the DPO approach is a crucial component (employed by the recommendation engine (202)) designed to dynamically refine and personalize the recommendation generation process (of the recommendation engine) based on real-time user interactions and preferences. The primary objective of the DPO approach is to align the recommendation engine's (202) outputs/recommendations directly with a related user's current preferences and needs, as demonstrated through his/her interactions with the framework (e.g., via the visualizer (204)). Unlike traditional recommendation systems that may rely heavily on static user profiles or historical data, the recommendation engine (202), by employing the DPO approach, may focus on user behaviors/actions to optimize its recommendations in real-time.

In one or more embodiments, by employing the DPO approach, the recommendation engine (202) may start continuous monitoring/capturing and analyzing of user actions (e.g., with respect to a product) (see Step 302 of FIG. 3.1). Continuous monitoring/capturing may include, for example, tracking products viewed by a user, added (by the user) to a quote, or removed (by the user) from a quote, as well as any explicit feedback provided by the user. The recommendation engine (202) may use these interactions to infer the user's current preferences. This inference may not merely be based on the products themselves but considers the context of each interaction, such as the sequence in which products are added or removed (by the user) and the combinations of products considered together. Based on the inferred preferences and by employing the DPO approach, the recommendation engine (202) may dynamically adjust its recommendation model's parameters (or the selection criteria). As indicated, this adjustment is not static; it evolves as more user interactions are observed, ensuring that the recommendation engine's (202) recommendations remain closely aligned with the user's current preferences.

In one or more embodiments, by employing the DPO approach, the recommendation engine (202) may (a) implement a feedback loop (e.g., after Step 324 of FIG. 3.2, the method may return to Step 308 of FIG. 3.1), (b) perform user preference weighting, and (c) become scalable and computationally efficient. The DPO approach may generate a feedback loop where the recommendation engine's (202) recommendations influence user actions, which in turn refine future recommendations (e.g., recommendations generated in Step 316 of FIG. 3.1). The feedback loop may allow the recommendation engine (202) to rapidly adapt to changes in user preferences, even within a single session (e.g., a session between a user (who is searching for a product) and a technical support representative).

The recommendation engine (202) may assign weights to different types of user interactions to signify their importance in indicating user preferences. For example, a product added to a cart (by a user) may carry more weight than a product merely viewed (by the user). Further, the DPO approach is scalable and computationally efficient (e.g., requiring fewer computing resources to operate), capable of handling numerous users and products without significant delays in processing. By employing the DPO approach, the recommendation engine (202) can operate in real-time.

Given a set of users U={u₁, u₂, . . . , uₙ} and a set of products/items I={i₁, i₂, . . . , iₘ}, the recommendation engine (202) may aim to recommend products to users based on their real-time interactions and preferences.

Let P(u, i) be the preference score of user “u” for product/item i, which is initially determined based on preprocessed data (e.g., historical data, user profiles, etc.) (see Step 306 of FIG. 3.1). During a session, as a user “u” interacts with items (via, for example, views, clicks, adds to cart, etc.), the recommendation engine (202) captures these interactions as a set Aᵤ={a₁, a₂, . . . , aₖ} in which each aⱼ is an action performed by the user. The preference model is then updated in real-time based on these analyzed actions (see Step 308 of FIG. 3.1), adjusting the preference scores P(u,i) accordingly:

$$P ( u , i ) = P ( u , i ) + λ {\sum }_{{a}_{j} ϵ {A}_{u}} δ ( i , {a}_{j} )$$

where λ is a learning rate parameter and δ(i,aⱼ) is a function that quantifies the impact of action aⱼ on the preference for item i. This function can be positive or negative, reflecting whether the action increases or decreases the user's preference for the item. The updated preference scores P(u,i)′ are used to generate a newer set of recommendations for the user, optimizing the recommendation list in real-time to reflect the user's latest preferences (see Steps 310 and 312 of FIG. 3.1). As indicated, the goal of the DPO approach (employed by the recommendation engine (202)) is to continuously adjust the preference scores and recommendations to align closely with the user's current interests/preferences and behaviors, ensuring a personalized and relevant recommendation experience.

In one or more embodiments, the recommendation model employed by the recommendation engine (202) may outline a dynamic process (e.g., to enforce the DPO approach) in which the recommendation engine adapts in real-time to user interactions, continuously refining its understanding of user preferences to optimize recommendation accuracy and relevance. The recommendation model may be initialized (by the recommendation engine (202)) using historical data (e.g., preprocessed data), setting up a baseline for understanding user preferences and behaviors. The recommendation engine (202) continuously monitors the user's real-time interactions with the framework, capturing actions of the user (e.g., product views, clicks on product icons, product adds to cart, product purchases, etc.).

In one or more embodiments, within a given active session, the recommendation engine (202) may capture every user action. These actions may be considered as crucial inputs for updating the recommendation model (e.g., the user preference model) employed by the recommendation engine (202). The recommendation engine (202) may update the user preference model in real-time based on the captured user actions, ensuring that the model reflects the user's current preferences. Using the updated user preference model (which generates an updated preference score for the user), the recommendation engine (202) may generate real-time recommendations (e.g., a set of potential recommendations) tailored to the user's current interests (see Step 314 of FIG. 3.1).

Once a set of recommendations are presented to the user (offering the user options that are aligned with his/her demonstrated preferences), the recommendation engine (202) may collect feedback from the user on the presented recommendations (see Step 324 of FIG. 3.2), which can include explicit feedback (e.g., positive ratings, negative ratings, etc.) or implicit feedback (e.g., ignoring or selecting a recommendation). Based on the collected feedback, the method performed by the recommendation engine (202) may return to Step 308 of FIG. 3.1 and the recommendation engine may adjust the recommendation model to improve future recommendations, ensuring that the recommendations become more accurate and personalized over time.

By optimizing recommendations based on direct and current user preferences (through the DPO approach), the recommendation engine (202) may ensure a high degree of personalization, enhancing user satisfaction and engagement. The DPO approach's real-time optimization functionality may allow the recommendation engine (202) to remain adaptable, capable of responding to changes in user preferences as they occur. Further, by providing more relevant and timely “potential” recommendations (via the DPO approach), the recommendation engine (202) may enable a related organization to reach higher conversion rates and increased customer satisfaction.

As indicated above, the DPO approach (employed by the recommendation engine (202)) represents a significant advancement in recommendation engine design, offering a dynamic and user-centered approach to generate personalized product/service recommendations. Through continuous analysis of user interactions and real-time adjustment of recommendations, the DPO approach ensures that the recommendations generated by the recommendation engine (202) are always aligned with the user's current preferences, thereby enhancing the overall effectiveness and user experience of the framework.

In one or more embodiments, to enhance its ability to generate high-quality, relevant, and strategically aligned recommendations, the recommendation engine (202) may employ the DOM with the TA methodology. As used herein, a DOM is a generative model that simulates the process of diffusion to generate a wide array of potential recommendations. Unlike traditional generative models that may directly output a fixed set of recommendations based on input data, the DOM iteratively refines its output, starting from a random distribution and progressively moving towards a distribution that represents optimal recommendations.

In one or more embodiments, the DOM (or the DOM approach, employed by the recommendation engine (202)) may perform its functionalities in different phases: (i) the initialization and generation phase, (ii) the diffusion phase, (iii) the learning and optimization phase, and (iv) the integration with the TA phase.

In the initialization and generation phase, the DOM may begin with a noise distribution, a random starting point that represents the vast potential space of product/service recommendations (e.g., the set of potential recommendations generated by the recommendation engine (202) by employing the DPO approach, see Step 314 of FIG. 3.1), in which the noise distribution may be analogous to the initial disordered state in a physical diffusion process. Thereafter, through a series of iterative steps, the DOM may gradually refine the initial noise, moving towards a distribution that represents meaningful and relevant recommendations. Each iteration of the DOM may reduce the randomness, incrementally introducing structure and relevance based on the underlying data and learned patterns.

In the diffusion phase, initially, the DOM may perform a forward diffusion process, gradually adding noise to the data (e.g., the set of potential recommendations). The forward diffusion process may help the DOM to understand how data transitions from a state of order (e.g., clear, structured data) to a state of disorder (e.g., random noise).

Subsequently, the DOM may initiate a reverse diffusion process, in which the DOM may learn to reconstruct the original data (e.g., the set of potential recommendations) from the noisy state. The reverse diffusion process is where the optimization occurs, as the DOM learns to identify and enhance patterns (and features) that lead to successful recommendations.

In the learning and optimization phase (and, in fact, throughout the diffusion processes), the DOM may learn from the available data (e.g., historical sales, user interactions, product information, etc.). This learning may enable the DOM to identify what characteristics and patterns are associated with successful recommendations. Thereafter, the DOM may optimize the generated recommendations (e.g., the set of potential recommendations) based on learned patterns and user preferences (see Step 316 of FIG. 3.1). This optimization is a continuous process, refined with each iteration, bringing the recommendation engine (202) closer to generate the optimal/optimized set of recommendations.

Let R be the set of potential recommendations. The diffusion process in the DOM starts with a broad and random initial distribution over R and iteratively refines this distribution towards a subset of R that aligns with user preferences and success criteria (e.g., optimization goals of a related organization). The process can be mathematically represented as follows:

1. Initialize a random distribution over R: D_0(R).

2. For each iteration t, perform the diffusion phase to add randomness:

Dₜ₊₁(R)=Dₜ(R)+ϵₜ where ϵₜ represents a noise factor.

3. Apply the reverse diffusion process to refine the recommendations, guided by a nonconformity measure that assesses how likely each recommendation is to succeed, based on the set of data (including, at least, historical data).

4. The process converges to a refined distribution D_{final}(R) that represents the optimized set of recommendations.

In the integration with the TA phase, the TA methodology plays a pivotal role in guiding the diffusion process by aligning the diffusion process with trajectories of historical recommendation successes. This alignment ensures that the recommendations (generated by the recommendation engine (202)) are not only relevant and personalized but also grounded in proven successful patterns and strategies. Further, the TA methodology ensures that the recommendations are aligned with objectives/goals of a related organization (e.g., maximizing margins), by guiding the generative process of the DOM toward products (and/or services) that meet these strategic goals.

In one or more embodiments, the TA methodology may use the set of data to identify paths (e.g., trajectories) of recommendation sequences that have led to successful recommendations. These trajectories may guide the reverse diffusion process in the DOM, ensuring that the recommendations (generated by the recommendation engine (202)) are not only relevant but also have a high likelihood of success.

Let T be a set of successful trajectories. The TA methodology aligns the diffusion process with T by minimizing the divergence between the current recommendation path and T:

$$TA ( {D}_{t} ( R ) , T ) = {min}_{{D}_{t} ( R )} \{ Divergence ( {D}_{t} ( R ) , T ) \} where Divergence ( {D}_{t} ( R ) , T )$$

measures the deviation of the current recommendation path from the successful trajectories T.

In one or more embodiments, by the end of the diffusion process, the DOM, guided by the TA methodology, enables the recommendation engine (202) to generate a set of refined/optimized, high-quality recommendations (see Step 316 of FIG. 3.1) that are tailored to the user's current preferences and aligned with strategic objectives of a related organization. The recommendation engine (202) may dynamically adapt its recommendations in real-time, responding to changes in user behavior, market conditions, or strategies of the organization, ensuring continuous relevance and strategic alignment. The employment of the DOM with the TA methodology by the recommendation engine (202) ensures that the generated recommendations are both user-centric and strategically aligned with historical success patterns, optimizing for relevance, success probability, and strategic alignment.

As discussed above, the recommendation model employed by the recommendation engine (202) may outline a process where the DOM and the TA methodology work in harmony so that the recommendation engine can generate, refine, and/or optimize recommendations, ensuring that the recommendations are not only user-relevant but also strategically aligned with objectives of a related organization.

The recommendation engine (202) may initialize the DOM with a broad and diverse set of potential recommendations, providing a starting point for the refinement/optimization process of the recommendation. The recommendation engine (202) may then use the set of data (e.g., obtained from the database (e.g., 135, FIG. 1)) to identify successful recommendation trajectories, which will serve as guides for the refinement process.

In one or more embodiments, the core of the DOM involves an iterative process in which each cycle refines the set of potential recommendations: (i) forward diffusion: introduce randomness into the set of potential recommendations, simulating the forward diffusion process which expands the search space, (ii) guided reverse diffusion: using historical success trajectories, the recommendation engine (202) guides the reverse diffusion to iteratively refine recommendations, gradually moving from a state of high randomness to structured, relevant suggestions, (iii) evaluation and alignment: at each iteration, the recommendation engine (202) evaluates each recommendation against the current user preferences to ensure relevance (to this end, the engine may apply the TA methodology to align these recommendations with established successful paths and strategic objectives (of a related organization), (iv) optimization: continuously optimize the set of potential recommendations to balance user preferences with the strategic objectives, ensuring that a final set of recommendations (e.g., a set of optimized recommendations) is both relevant to the user and beneficial for the organization. Once the iterative process is complete, via the visualizer (204), the optimized set of recommendations may be presented to the user (see Step 322 of FIG. 3.2), offering recommendations that are finely tuned to both the user's current needs/preferences and the organization's strategic objectives.

In one or more embodiments, the recommendation engine (202) may employ conformal prediction (or conformal prediction techniques) for confidence interval. In this step, by applying conformal prediction, the recommendation engine (202) may focus on quantifying the uncertainty and reliability of the generated recommendations (e.g., the set of optimized recommendations). This step is crucial for ensuring that the recommendations are not only relevant and strategic but also trustworthy.

As used herein, conformal prediction is a statistical technique used to determine the reliability of predictions performed by ML models. Conformal prediction provides a way to calculate confidence intervals (or p-values) for each prediction, offering a measure of certainty (or uncertainty) associated with that prediction. Further, conformal prediction provides a way to assess the reliability of predictions made by an ML model, assigning confidence intervals to these predictions based on previous performance.

Assume here that the recommendation engine (202) considers a set of items/products I={i₁, i₂, . . . , iₘ} and a set of users U={u₁, u₂, . . . , uₙ}. For a given user u∈U and item i∈I, the recommendation engine (202) predicts a preference score [symbol] based on historical interaction data. For each item i∈I recommended to user u, the recommendation engine (202) calculates a nonconformity score α_{u,i}, which measures how much the item i deviates from user u's typical preferences.

The nonconformity score α_{u,i} for an item i and user u is given by:
α_{u,i}=| [symbol] −median(Pᵤ)| where Pᵤ is the set of preference scores for user u across all items, and [symbol] is the predicted preference score for item i. Thereafter, the p-value for each item can be computed as:

$${p}_{u , i} = \frac{\vert \{ j : {α}_{u , j} \geq {α}_{u , i} \} \vert}{\vert I \vert} where \vert I \vert$$

is the total number of items and α_{u,j} is the nonconformity score for all items j considered for user u. The recommendation engine (202) then determines the confidence interval for the prediction by selecting the range of scores for which the p-value remains above a significance level E.

In one or more embodiments, the recommendation engine (202) applies conformal prediction to each recommendation, providing a confidence interval that reflects the historical accuracy and reliability of the predictions: (i) high p-value recommendations are those where the predicted preference score is close to the user's typical preference scores, indicating higher confidence and (ii) low p-value recommendations, on the other hand, indicate that the item is an outlier and thus less reliably predicted.

In one or more embodiments, after the recommendation engine (202), employing the DPO approach and the DOM with the TA methodology, generates a list of potential recommendations, and assigns a predictive score to each item/product/service based on the user's likely interest or the predicted success of the item. The recommendation engine (202) then calculates a nonconformity score for each recommendation, which is a measure of how much each recommendation deviates from the typical recommendations made in similar contexts. This measure is based on historical data and the predictive scores, assessing the degree to which a particular recommendation is atypical or conforming.

Further, for each recommendation, the recommendation engine (202) computes a p-value based on the nonconformity scores, in which the p-value represents the probability that the recommendation is consistent with the user's preferences and behavior patterns seen in the historical data. Using the p-values, the recommendation engine (202) calculates confidence intervals for each recommendation (see Step 318 of FIG. 3.1). These intervals provide a statistical measure of the reliability of the recommendations, indicating the range within which the true value of the recommendation's effectiveness is likely to fall.

In one or more embodiments, the confidence intervals provided with each recommendation may help users and/or salespeople to make more informed decisions. For example, users can understand which recommendations are made with high confidence and which ones are more exploratory (or uncertain). By quantifying the uncertainty of recommendations, conformal prediction assists in managing the risk associated with adopting newer or less familiar products. For example, users can weigh the potential benefits of a recommendation against its confidence level.

Further, the recommendation engine (202) may dynamically adjust confidence intervals based on real-time user feedback and interactions. If a user consistently follows certain types of recommendations, the recommendation engine (202) may learn and adjust confidence intervals, for example, increasing the confidence intervals of similar future recommendations. In one or more embodiments, the feedback loop may also allow the recommendation engine (202) to continuously improve its predictive accuracy and the reliability of its confidence intervals, leading to a more trustworthy and effective recommendation generation over time.

As indicated above, conformal prediction is employed (by the recommendation engine (202)) to assess and quantify the confidence level of each recommendation, adding a layer of statistical validation to the recommendation generation process. This step enhances the credibility of the recommendation engine (202) and helps users (and/or salespeople) in making more informed decisions by understanding the reliability of the recommendations provided.

The recommendation engine (202) may first identify a set of optimized recommendations, which have been tailored based on user preferences and objectives of a related organization. A nonconformity measure may then be established, using historical data, to evaluate how much each recommendation deviates from typical recommendations. In one or more embodiments, for each recommendation in the set, the recommendation engine (202) may: (i) calculate a nonconformity score: determine how much each recommendation deviates from the norm established by previously successful recommendations (producing a nonconformity score), (ii) determine p-values: based on these nonconformity scores, compute p-values for each recommendation, which represent the likelihood that these recommendations are in line with previously successful recommendations, and (iii) compute confidence interval: use the p-values to calculate confidence intervals for each recommendation, giving a statistical measure of their reliabilities.

Once confidence intervals are calculated, the recommendation engine (202) may rank the recommendations based on these intervals (see Step 320 of FIG. 3.2). In one or more embodiments, recommendations with higher confidence levels may be prioritized. Thereafter, the recommendations, along with their confidence intervals, may be presented to a related user (see Step 322 of FIG. 3.2). This presentation may allow the user to make informed decisions based on the perceived reliability of each recommendation.

Conformal prediction allows the recommendation engine (202) to manage risk by providing a quantifiable measure of confidence or uncertainty for each recommendation. Users can make more informed decisions by considering these confidence intervals, especially when exploring newer or alternative products/service. The recommendation engine (202) may dynamically update the confidence intervals based on ongoing user interactions and feedback. If certain types of recommendations consistently perform well, the recommendation engine (202) may adjust to reflect higher confidence levels for similar future recommendations.

User responses to recommendations (e.g., acceptance of a recommendation, rejection of a recommendation, requesting a modification to a recommendation, etc.) may be used (by the recommendation engine (202)) to continually refine the conformal prediction model. This feedback loop (where the method performed by the recommendation engine (202) may return to Step 308 of FIG. 3.1 after Step 324 of FIG. 3.2) ensures that the confidence intervals become more accurate over time, reflecting the evolving preferences of the user and the changing dynamics of the market. By providing confidence intervals, the recommendation engine (202) can align recommendations not only with user preferences but also with strategies of a related organization. High-confidence recommendations that also align with high-margin products (and/or strategic goals of the organization) can be prioritized.

In one or more embodiments, employment of conformal prediction for confidence intervals by the recommendation engine (202) ensures a statistically grounded, transparent, and adaptive recommendation generation process. Conformal prediction enhances the recommendation engine's (202) capability to provide reliable, personalized, and strategically aligned recommendations, thereby significantly improving the overall user experience and performance of a related organization.

In one or more embodiments, via the visualizer (204) (e.g., via a GUI, an API, a programmatic interface, and/or a communication channel of the visualizer), the recommendation engine (202) may present its recommendations to a user and/or a salesperson. The recommendation engine (202) ensures that the recommendations are not only relevant and personalized but also strategically aligned with objectives of a related organization (e.g., who manufactures a recommended product).

In one or more embodiments, the recommendation engine (202) may integrate the outputs from the previous steps/phases, including the preferences identified through the DPO approach, the potential recommendations generated through the DOM, and the strategic paths identified through the TA methodology, in which each potential recommendation is evaluated through conformal prediction techniques to ascertain its confidence interval, providing a quantifiable measure of reliability.

The recommendation engine (202) may then refine the recommendations to ensure the recommendations are highly relevant to the user's current context and preferences. This involves analyzing the latest interactions and feedback from the user to tailor the recommendations closely to his/her needs. The recommendations are also evaluated (by the recommendation engine (202)) against objectives of a related organization, such as maximizing margins or promoting strategic products. The recommendation engine (202) may then prioritize recommendations that align with these objectives, ensuring that the recommendations support the organization's broader strategic aims.

In one or more embodiments, the recommendation engine (202) may prioritize recommendations based on a combination of their confidence ratings and potential contribution to margins of the organization. High-confidence recommendations that also offer higher margins may be given precedence (while presenting the recommendations to the user via the visualizer (204)). The recommendations may be sequenced/ranked in a manner that maximizes user engagement and organization impact. The sequencing strategy considers the likelihood of user interests and the strategic importance of each recommendation (from the perspective of the organization), ensuring an optimal balance between user satisfaction and organization value (associated with each recommendation).

In one or more embodiments, the finalized set of recommendations (e.g., the ranked list of recommendations) may then be prepared for presentation (via the visualizer (204)), ensuring that each recommendation is accompanied by relevant details (e.g., product descriptions, confidence levels/intervals associated with each recommendation, any other pertinent information that would help the user's decision-making process, etc.). For a user-centric presentation, upon receiving the ranked list of recommendations (along with the relevant details), the visualizer (204) may format the ranked list of recommendations in a user-friendly manner (e.g., to enhance the likelihood of user acceptance and satisfaction, while driving towards favorable organization related outcomes), highlighting key information and insights that can guide the user in his/her, for example, product selection process.

Further, the visualizer (204) may include functionality to, e.g.: (i) obtain (or receive) data (e.g., any type and/or quantity of input) from any source (e.g., a user via a client (e.g., 110A, FIG. 1), the recommendation engine (202), etc.) (and, if necessary, aggregate the data); (ii) based on (i) and by employing a set of linear, non-linear, and/or ML models, analyze, for example, a query to derive additional data; (iii) encompass hardware and/or software components and functionalities provided by the IN (200) to operate as a service over the network (e.g., 130, FIG. 1) so that the visualizer (204) may be used externally; (iv) employ a set of subroutine definitions, protocols, and/or hardware/software components for enabling/facilitating communications between, for example, the recommendation engine (202) and external entities (e.g., clients, administrators, etc.); (v) by generating one or more visual elements, allow an administrator to, at least, interact with a user of a corresponding client; (vi) receive a customer/user profile of a customer and display the customer profile to an administrator (e.g., for monitoring and/or performance evaluation); (vii) concurrently display one or more separate windows, for example, on its GUI; and/or (viii) generate visualizations of the method illustrated in FIGS. 3.1-3.2.

In one or more embodiments, to ensure the recommendation engine's (202) recommendations remain accurate, relevant, and aligned with both user preferences and objectives of a related organization over time, the recommendation engine (202) may implement a feedback loop.

As users interact with the recommendation engine's (202) recommendations (via a GUI of the visualizer (204)), users' actions (e.g., accepting, modifying, or rejecting recommendations) are meticulously tracked/monitored (by the recommendation engine (202)) to obtain users' feedback (on presented recommendations). This feedback, whether explicit (through ratings or comments) or implicit (through behavioral data such as clicks and/or purchase history), is crucial for understanding of user responses to the presented recommendations. As indicated above, the collected feedback is integrated into the recommendation engine (202) in real-time, allowing for the engine's immediate analysis and response. This integration ensures that the recommendation engine (202) can quickly adapt to changes in user preferences/behaviors.

In one or more embodiments, the recommendation engine (202) may analyze the collected feedback to identify patterns (or trends) in user behavior (see Step 308 of FIG. 3.1). This analysis may help the recommendation engine (202) to determine which aspects of the recommendations are resonating with the user and which are not. Based on this analysis, the recommendation engine's (202) underlying models, including those for the DOM approach and the DOM, may be updated (e.g., fine-tuned, retrained, etc.) to reflect the newly acquired insights/feedback. This updating process may involve retraining the models with newer data or adjusting the models' parameters to better capture user preferences and behaviors.

In one or more embodiments, the recommendation engine (202) may engage in an iterative learning process, where the engine continuously refines its recommendation models based on ongoing user feedback. This process ensures that the recommendation engine (202) becomes more accurate and effective over time. The recommendations are dynamically adjusted to reflect the updated models, which ensures that the recommendation engine (202) can promptly respond to changes in user preferences, market trends, and/or organization strategies.

In one or more embodiments, the feedback loop may also allow the recommendation engine (202) to reevaluate and realign its recommendations with current objectives of a related organization. If priorities/objectives of the organization are shifting, the recommendation engine (202) can adapt its recommendation strategies to ensure the recommendations remain optimally aligned with these objectives. Further, the recommendation engine (202) may continuously monitor its performance, evaluating metrics such as user engagement, conversion rates, and profitability. Insights from this monitoring may be used (by the recommendation engine (202)) to further refine and optimize the recommendation generation process.

In one or more embodiments, the feedback loop (performed by the recommendation engine (202)) may ensure that the recommendation engine is not a static component but a dynamic component, an evolving entity that learns from user interactions and adapts to changing preferences and conditions. The feedback loop may maintain the recommendation engine's (202) relevance, accuracy, and strategic alignment, enhancing user satisfaction and driving organization success. Further, the feedback loop may encapsulate the recommendation engine's (202) ability to learn from its environment and improve over time. By establishing a robust feedback loop and engaging in continuous learning and adaptation, the recommendation engine (202) ensures that its recommendations remain highly personalized, strategically aligned, and effective in achieving desired organization outcomes, embodying a truly intelligent and responsive recommendation engine.

As discussed above, the recommendation engine (202) may provide enhanced personalization. The recommendation engine (200) may dynamically adapt to user preferences and behavior in real-time, with the help of the DPO approach, ensuring that recommendations are highly personalized and relevant to each user's current context and needs. The recommendation engine (202) may also provide strategic organization alignment. Through the integration of margin optimization strategies and conformal prediction, the recommendation engine (202) may align its recommendations with objectives of organizations, particularly in maximizing profit margins. This alignment ensures that while catering to user preferences, the recommendations also contribute to a related organization's financial goals.

Further, the recommendation engine (202) may provide improved decision-making with confidence intervals. By employing conformal prediction techniques, the recommendation engine (202) may determine confidence intervals for each recommendation, offering users and decision-makers a quantifiable measure of trust in the recommendations (generated by the engine). This transparency enhances the decision-making process, allowing for more informed and risk-assessed choices. The recommendation engine (202) may provide real-time adaptability and responsiveness. The recommendation engine's (202) employment of the DOM and the TA methodology may allow for real-time adaptability to changes in user behaviors and preferences, ensuring that recommendations remain relevant and timely throughout the user interaction process.

In one or more embodiments, the recommendation engine (202) may enable increased efficiency and scalability. The efficient design of the recommendation engine (202), particularly through the use of diffusion processes and preference optimization, ensures that the engine can handle large sets of data without compromising on performance (of the IN (200)), making the engine scalable across different organization sizes and industries. The recommendation engine (202) may also enable continuous learning and improvement. The feedback loop and continuous improvement mechanisms (employed by the recommendation engine (202)) ensure that the recommendation engine (202) evolves over time, learning from user interactions and market changes to enhance the accuracy and relevance of its recommendations.

Moreover, the recommendation engine (202) may provide risk management. By providing confidence intervals and allowing for dynamic adjustment based on real-time feedback, the recommendation engine (202) may effectively manage the inherent risks in recommendation generation processes, balancing user satisfaction with organization expectations. The recommendation engine (202) may also provide cross-industry applicability. The recommendation engine's (202) flexible and adaptive nature makes the engine suitable for various industries, from retail and e-commerce to healthcare and financial services, allowing for wide-ranging applications and benefits.

One of ordinary skill will appreciate that the recommendation engine (202) may perform other functionalities without departing from the scope of the embodiments disclosed herein. The recommendation engine (202) may be implemented using hardware (e.g., any number of integrated circuits for processing computer readable instructions), software (e.g., a computer program executing on the underlying hardware of the IN (200)), or any combination thereof.

One of ordinary skill will appreciate that the visualizer (204) may perform other functionalities without departing from the scope of the embodiments disclosed herein. The visualizer (204) may be implemented using hardware, software, or any combination thereof.

In one or more embodiments, the recommendation engine (202) and the visualizer (204) may be utilized in isolation and/or in combination to provide the aforementioned functionalities. These functionalities may be invoked using any communication model including, for example, message passing, state sharing, memory sharing, etc.

FIGS. 3.1-3.2 show a method for managing recommendation generation in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

Turning now to FIG. 3.1, the method shown in FIG. 3.1 may be executed by, for example, the above-discussed the recommendation engine (e.g., 202, FIG. 2) and the visualizer (e.g., 204, FIG. 2). Other components of the system (100) illustrated in FIG. 1 may also execute all or part of the method shown in FIG. 3.1 without departing from the scope of the embodiments disclosed herein.

In Step 300, the recommendation engine receives, via the visualizer, a request (e.g., a product ordering request) from an entity (e.g., a user of/via a client (e.g., 110A, FIG. 1), a web application that is being used by the user, an application terminal of an IN (e.g., 200, FIG. 2) that is being used by an administrator, etc.). In one or more embodiments, the request may specify, for example (but not limited to): an identifier of a user, details of a product order received from the user, information associated with a product, etc.

In Step 302, upon receiving the request in Step 300, the recommendation engine obtains a set of data (e.g., popularity or user preference history of a product, financial data (e.g., current profit margins of a related organization, cost variations of the product, product inventory levels, etc.), historical sales data of the product, historical user data related to the product, information associated with the product, profitability information associated with the product, etc., additional details are discussed above in reference to FIG. 1) from a database (e.g., 135, FIG. 1). In one or more embodiments, before obtaining the set of data, the recommendation engine may invoke the database to communicate with the database. After receiving the database's confirmation, the recommendation engine may obtain the set of data from the database. The set of data may be obtained continuously or at regular intervals (e.g., every two minutes) (without affecting production workloads of the database and the recommendation engine). Further, the set of data may be access-protected for the transmission from, for example, the database to the recommendation engine, e.g., using encryption.

In one or more embodiments, the set of data may be obtained as they become available or by the recommendation engine polling the database (via one or more API calls) for newer information. For example, based on receiving an API call from the recommendation engine, the database may allow the recommendation engine to obtain newer information.

Further, upon receiving the request in Step 300, the recommendation engine start monitoring/capturing actions of the user (with respect to the product) in real-time (or near real-time).

In Step 304, by employing a set of linear, non-linear, and/or ML models, the recommendation engine performs preprocessing on the set of data to obtain preprocessed data. The preprocessing may include performing feature extraction to extract features from the set of data to be used while generating a set of potential product recommendations. Additional details of the preprocessing are discussed above in reference to FIG. 2. In Step 306, based on the preprocessed data, the recommendation engine determines a preference score of the user (for the product). In Step 308, by employing a set of linear, non-linear, and/or ML models, the recommendation engine analyzes the actions (of the user) (e.g., viewing information related to a second product on a website, adding the second product to a quote, removing a third product from the quote, initiating a technical support call for the product, etc.) in real-time to obtain an analysis result. In Step 310, based on the analysis result, the recommendation engine infers current preferences of the user with respect to the product (e.g., User A seems to prefer Product T's version 77, assigning weights to different types of user actions to infer the current preference of the user, etc.). In Step 312, based on the current preferences, the recommendation engine updates the preference score (of the user) to obtain an updated preference score of the user. In one or more embodiments, the updated preference score may indicate an increased product ordering tendency of the user to order to product (e.g., a computing device).

In Step 314, based on the updated preference score, the recommendation engine generates a set of potential product recommendations for the user. In one or more embodiment, to perform Steps 306-314, the recommendation engine may employ the DPO approach. In Step 316, by employing the DOM guided by the TA methodology, the recommendation engine generates a set of optimized/refined product recommendations (e.g., a set of personalized, strategically aligned, and dynamically adaptable recommendations) for the user based on the set of potential product recommendations. In one or more embodiments, each of the set of optimized product recommendations is further generated based on a margin maximization objective of a related organization that manufactures the product.

In Step 318, by employing conformal prediction (or a conformal prediction model), the recommendation engine determines a reliability of each of the set of optimized product recommendations based on each recommendation's confidence interval.

In one or more embodiments, a confidence interval of an optimized product recommendation of the set of optimized product recommendations may specify a statistical measure of a reliability of the optimized product recommendation.

Turning now to FIG. 3.2, the method shown in FIG. 3.2 may be executed by, for example, the recommendation engine and the visualizer. Other components of the system (100) illustrated in FIG. 1 may also execute all or part of the method shown in FIG. 3.2 without departing from the scope of the embodiments disclosed herein.

In Step 320, the recommendation engine ranks each of the set of optimized product recommendations based on confidence intervals to generate a ranked list of product recommendations. In Step 322, via a GUI of the visualizer, the recommendation engine initiates display of the ranked list of product recommendations along with, at least, each recommendation's confidence interval to the user.

In Step 324, based on Step 322, the recommendation engine makes a determination (in real-time or near real-time) as to whether a positive feedback (with respect to the product recommendations) is received. Accordingly, in one or more embodiments, if the result of the determination is YES, the method may end following Step 324. If the result of the determination is NO (e.g., a negative feedback is received, no feedback is received, etc.), the method alternatively returns to Step 308 of FIG. 3.1.

In one or more embodiments, once the ranked list of product recommendations are presented to the user (offering them options that are aligned with his/her demonstrated preferences), the recommendation engine may collect feedback from the user on the presented recommendations, which can include explicit feedback (e.g., positive ratings, negative ratings, etc.) or implicit feedback (e.g., ignoring or selecting a recommendation). Based on the collected feedback over the GUI of the visualizer, the method may return to Step 308 of FIG. 3.1 and the recommendation engine may adjust the recommendation model to improve future recommendations, ensuring that the recommendations become more accurate and personalized over time.

For example, the recommendation engine may make a determination that a negative feedback is received, over the GUI, from the user, in which the negative feedback indicates that the ranked list does not satisfy expectations of the user related to the product. Based on the determination, the engine may update the ranked list to obtain an updated ranked list of product recommendations. Thereafter, the engine may initiate, via the GUI of the visualizer, display of the updated ranked list to the user.

Referring to FIGS. 2, 3.1, and 3.2, (i) unlike static models, the combination of the DPO approach and the DOM allows the recommendation engine (202) to dynamically adapt its recommendations based on real-time user interactions (this means the recommendation engine can instantly respond to changes in user behaviors or preferences, making the recommendations highly relevant and timely), (ii) the DPO approach leverages real-time user feedback to continuously refine and personalize the recommendation generation process (of the recommendation engine), in which the approach ensures that the engine's recommendations are closely aligned with the user's current needs and interests, (iii) via the DOM approach, the engine employs a generative recommendation model that iteratively refines recommendations, effectively utilizing both historical and real-time data (in which, this method allows for a more nuanced understanding of user preferences and market trends, leading to more accurate and strategic recommendations), (iv) the integration of the DPO approach and the DOM facilitates not only user-centered personalization but also ensures that the recommendations are aligned with goals of a related organization, in which the recommendation engine can dynamically optimize recommendations to balance user satisfaction with objectives of the organization, (v) the TA methodology utilizes historical data to identify successful recommendation trajectories and aligns the current recommendation process (of the engine) with these proven paths (this approach ensures that the recommendations are not only based on current user interactions but also informed by historical patterns of success, providing a more robust and contextually rich recommendation strategy), (vi) unlike static models, the TA methodology allows (the engine) for dynamic adaptation of the recommendation paths based on real-time user interactions and changing market conditions (this dynamism ensures that the recommendations remain relevant and effective over time, capturing emerging trends and shifts in user behaviors), (vii) the TA methodology ensures that the recommendations are strategically aligned with goals of the organization (by aligning the recommendation generation process with successful historical trajectories, the engine can naturally promote products (or services) that align with strategic objectives of the organization), (viii) employing conformal prediction provides a statistical measure of confidence for each recommendation, giving users a quantifiable insight into the reliability of each recommendation (e.g., users can see which recommendations are made with high confidence and which are more speculative), (ix) confidence intervals allow the recommendation engine to be more dynamic and adaptive, in which the recommendations can be adjusted in real-time based on the evolving confidence intervals/levels, ensuring that users always receive suggestions that are not only relevant but also reliable, (x) with confidence intervals, users can better manage the risks associated with different recommendations (as the users can make more informed decisions by considering both the potential benefits of a recommendation and the confidence level associated with it), (xi) the recommendation engine dynamically incorporates real-time financial data, including profit margins, inventory levels, and sales targets, into its recommendation model(s), in which this integration ensures that the recommendations are not only suitable for the user but also financially optimal for the organization, (xii) based on the recommendation engine's ability to adapt its recommendation model in real-time based on current financial data and organization, the engine can prioritize high-margin products, adjust recommendations to liquidate overstock, or promote newer items with strategic importance, thereby optimizing profit margins continuously, (xiii) the recommendation engine's recommendations are aligned with the organization's broader financial and strategic goals, ensuring that each recommendation contributes to the overall financial health of the organization (this alignment is dynamic and adjusts as organization strategies evolve over time), (xiv) the recommendation engine employs advanced models/approaches (e.g., the DPO approach, the DOM, etc.) to continuously learn from user interactions, adapting recommendations in real-time to enhance user engagement and satisfaction (this approach ensures a high degree of personalization and relevance in the generated recommendations), (xv) conformal prediction techniques are utilized (by the engine) to estimate the confidence intervals of recommendations, providing a quantifiable measure of risk (in which the employment of these techniques allows the engine to manage the uncertainty associated with each recommendation, aligning user preferences with the organization's risk tolerance levels), and/or (xvi) the engine's risk management strategies are not static; these strategies adapt based on real-time data (e.g., user feedback, market trends, objectives of the organization, etc.), in which this adaptive approach ensures that the engine's risk management is always aligned with the current organization environment and user preferences.

Turning now to FIG. 4, FIG. 4 shows a diagram of a computing device in accordance with one or more embodiments disclosed herein.

In one or more embodiments disclosed herein, the computing device (400) may include one or more computer processors (402), non-persistent storage (404) (e.g., volatile memory, such as RAM, cache memory), persistent storage (406) (e.g., a non-transitory computer readable medium, a hard disk, an optical drive such as a CD drive or a DVD drive, a Flash memory, etc.), a communication interface (412) (e.g., Bluetooth interface, infrared interface, network interface, optical interface, etc.), an input device(s) (410), an output device(s) (408), and numerous other elements (not shown) and functionalities. Each of these components is described below.

In one or more embodiments, the computer processor(s) (402) may be an integrated circuit for processing instructions. For example, the computer processor(s) (402) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (e.g., a LAN, a WAN, Internet, mobile network, etc.) and/or to another device, such as another computing device.

In one or more embodiments, the computing device (400) may include one or more output devices (408), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for managing recommendation generation, the method comprising:
receiving a product ordering request from a user via a computing device,
wherein the request comprises information associated with a product;
upon receiving the request:
obtaining a set of data from a database, wherein the computing device and the database are connected to each other over a network;
initiating monitor of actions of the user with respect to the product in real-time;
performing preprocessing on the set of data to obtain preprocessed data;
determining, based on the preprocessed data, a preference score of the user for the product;
analyzing the actions to obtain an analysis result;
inferring, based on the analysis result, a current preference of the user related to the product;
updating, based on the current preference, the preference score to obtain an updated preference score of the user;
generating, based on the updated preference score, a set of potential product recommendations for the user;
generating, using a diffusion optimized model guided by trajectory alignment, a set of optimized product recommendations for the user based on the set of potential product recommendations;
determining, using a conformal prediction model, a reliability of each of the set of optimized product recommendations based on each optimized product recommendation's confidence interval;
ranking each of the set of optimized product recommendations based on confidence intervals to generate a ranked list of product recommendations;
initiating, via a graphical user interface (GUI) of a visualizer, display of the ranked list to the user along with each optimized product recommendation's confidence interval;
after displaying the ranked list:
making a determination that a negative feedback is received, over the GUI, from the user, wherein the negative feedback indicates that the ranked list does not satisfy expectations of the user related to the product;
updating, based on the determination, the ranked list to obtain an updated ranked list of product recommendations; and
initiating, via the GUI, display of the updated ranked list to the user.

2. The method of claim 1, wherein a confidence interval of an optimized product recommendation of the set of optimized product recommendations specifies a statistical measure of a reliability of the optimized product recommendation.

3. The method of claim 1, wherein the actions of the user comprise viewing information related to a second product on a website, adding the second product to a quote, removing a third product from the quote, and initiating a technical support call for the product.

4. The method of claim 1, wherein the set of data comprises historical sales data of the product, historical user data related to the product, information associated with the product, and profitability information associated with the product.

5. The method of claim 1, wherein the preprocessing comprises performing feature extraction to extract features from the set of data to be used while generating the set of potential product recommendations.

6. The method of claim 1, wherein the inferring comprises assigning weights to different types of user actions to infer the current preference of the user.

7. The method of claim 1,
wherein the updated preference score indicates an increased product ordering tendency of the user to order to product, and
wherein the product is a second computing device.

8. The method of claim 1, wherein each of the set of optimized product recommendations is further generated based on a margin maximization objective of a related organization that manufactures the product.

9. A non-transitory computer readable medium comprising computer readable program code, which when executed by a computer processor enables the computer processor to perform a method for managing recommendation generation, the method comprising:
receiving a product ordering request from a user via a computing device,
wherein the request comprises information associated with a product;
upon receiving the request:
obtaining a set of data from a database, wherein the computing device and the database are connected to each other over a network;
initiating monitor of actions of the user with respect to the product in real-time;
performing preprocessing on the set of data to obtain preprocessed data;
determining, based on the preprocessed data, a preference score of the user for the product;
analyzing the actions to obtain an analysis result;
inferring, based on the analysis result, a current preference of the user related to the product;
updating, based on the current preference, the preference score to obtain an updated preference score of the user;
generating, based on the updated preference score, a set of potential product recommendations for the user;
generating, using a diffusion optimized model guided by trajectory alignment, a set of optimized product recommendations for the user based on the set of potential product recommendations;
determining, using a conformal prediction model, a reliability of each of the set of optimized product recommendations based on each optimized product recommendation's confidence interval;
ranking each of the set of optimized product recommendations based on confidence intervals to generate a ranked list of product recommendations;
initiating, via a graphical user interface (GUI) of a visualizer, display of the ranked list to the user along with each optimized product recommendation's confidence interval;
after displaying the ranked list:
making a determination that a negative feedback is received, over the GUI, from the user, wherein the negative feedback indicates that the ranked list does not satisfy expectations of the user related to the product;
updating, based on the determination, the ranked list to obtain an updated ranked list of product recommendations; and
initiating, via the GUI, display of the updated ranked list to the user.

10. The non-transitory computer readable medium of claim 9, wherein a confidence interval of an optimized product recommendation of the set of optimized product recommendations specifies a statistical measure of a reliability of the optimized product recommendation.

11. The non-transitory computer readable medium of claim 9, wherein the actions of the user comprise viewing information related to a second product on a website, adding the second product to a quote, removing a third product from the quote, and initiating a technical support call for the product.

12. The non-transitory computer readable medium of claim 9, wherein the set of data comprises historical sales data of the product, historical user data related to the product, information associated with the product, and profitability information associated with the product.

13. The non-transitory computer readable medium of claim 9, wherein the preprocessing comprises performing feature extraction to extract features from the set of data to be used while generating the set of potential product recommendations.

14. The non-transitory computer readable medium of claim 9, wherein the inferring comprises assigning weights to different types of user actions to infer the current preference of the user.

15. The non-transitory computer readable medium of claim 9,
wherein the updated preference score indicates an increased product ordering tendency of the user to order to product, and
wherein the product is a second computing device.

16. The non-transitory computer readable medium of claim 9, wherein each of the set of optimized product recommendations is further generated based on a margin maximization objective of a related organization that manufactures the product.

17. A system for managing recommendation generation, the system comprising:
a processor comprising circuitry;
memory comprising instructions, which when executed perform a method, the method comprising:
receiving a product ordering request from a user via a computing device, wherein the request comprises information associated with a product;
upon receiving the request:
obtaining a set of data from a database, wherein the computing device and the database are connected to each other over a network;
initiating monitor of actions of the user with respect to the product in real-time;
performing preprocessing on the set of data to obtain preprocessed data;
determining, based on the preprocessed data, a preference score of the user for the product;
analyzing the actions to obtain an analysis result;
inferring, based on the analysis result, a current preference of the user related to the product;
updating, based on the current preference, the preference score to obtain an updated preference score of the user;
generating, based on the updated preference score, a set of potential product recommendations for the user;
generating, using a diffusion optimized model guided by trajectory alignment, a set of optimized product recommendations for the user based on the set of potential product recommendations;
determining, using a conformal prediction model, a reliability of each of the set of optimized product recommendations based on each optimized product recommendation's confidence interval;
ranking each of the set of optimized product recommendations based on confidence intervals to generate a ranked list of product recommendations;
initiating, via a graphical user interface (GUI) of a visualizer, display of the ranked list to the user along with each optimized product recommendation's confidence interval;
after displaying the ranked list:
making a determination that a negative feedback is received, over the GUI, from the user, wherein the negative feedback indicates that the ranked list does not satisfy expectations of the user related to the product;
updating, based on the determination, the ranked list to obtain an updated ranked list of product recommendations; and
initiating, via the GUI, display of the updated ranked list to the user.

18. The system of claim 17, wherein a confidence interval of an optimized product recommendation of the set of optimized product recommendations specifies a statistical measure of a reliability of the optimized product recommendation.

19. The system of claim 17, wherein the actions of the user comprise viewing information related to a second product on a website, adding the second product to a quote, removing a third product from the quote, and initiating a technical support call for the product.

20. The system of claim 17, wherein the set of data comprises historical sales data of the product, historical user data related to the product, information associated with the product, and profitability information associated with the product.
